(19) United States
(12) Patent Application Publication
(10) Pub. No.: US 2023/0154462 A1
(43) Pub. Date: May 18, 2023

(54) ELECTRONIC DEVICE AND METHOD OF RESTORING DEVICE STATE

(71) Applicant: Samsung Electronics Co., Ltd., Gyeonggi-do (KR)

(72) Inventors: Junho LEE, Gyeonggi-do (KR); Youngsub KO, Gyeonggi-do (KR); Joohwan KIM, Gyeonggi-do (KR); Jaechul LEE, Gyeonggi-do (KR); Youngjin JEON, Gyeonggi-do (KR)

(21) Appl. No.: 17/965,139

(22) Filed: Oct. 13, 2022

Related U.S. Application Data
(63) Continuation of application No. PCT/KR2022/012513, filed on Aug. 22, 2022.

(30) Foreign Application Priority Data
Nov. 18, 2021 (KR) 10-2021-0159266

(51) Int. Cl. G10L 15/22

(52) U.S. Cl. CPC G10L 15/22

(57) ABSTRACT

According to an embodiment, an electronic device, comprising: a memory configured to store instructions; and a processor electrically connected to the memory and configured to execute the instructions, wherein, when the instructions are executed by the processor, the processor performs a plurality of operations, the plurality of operations comprising: when a first utterance from a user is a command for a target device, obtaining state information for an original state of the target device; and generating reverse voice metadata for the target device to revert to the original state from a post-utterance state of the target device based on the state information on the original state, wherein the original state is a state of the target device before being changed by the first utterance, and the post-utterance state is a state of the target device changed by the first utterance.

### CROSS REFERENCE TO RELATED APPLICATIONS

This application is a continuation of International Application No. PCT/KR2022/012513 designating the United States, filed on Aug. 22, 2022, in the Korean Intellectual Property Receiving Office and claiming priority to Korean Patent Application No. 10-2021-0159266, filed on Nov. 18, 2021, in the Korean Intellectual Property Office, the disclosures of which are incorporated by reference herein in their entireties.

### BACKGROUND

### 1. Field

The disclosure relates to an electronic device and a method of restoring a device state.

### 2. Description of Related Art

A user may receive various services using an electronic device. For example, a device can provide voice recognition to enable a voice assistant (e.g., a voice assistant service). A voice assistant service allows a user to input an utterance (e.g., speech) to an electronic device and receive a response message in response to the input utterance.

In addition, the electronic device may perform functions or support another electronic device (e.g., an Internet of things (IoT) device) to perform functions, based on the voice assistant recognizing the input utterance (e.g., a voice command). Voice command-based device control may include understanding a user’s intent from the voice command and executing a device command desired by the user.

### SUMMARY

Controlling an electronic device through a voice assistant may support the execution of a single command (e.g., an action corresponding to the command) matching a user’s intent determined or understood from a voice input (e.g., a voice command), and support the sequential execution of a plurality of commands required by conditions before the execution of the single command. For example, in response to a single voice input “Change to the Netflix viewing mode,” resultant commands can include (1) a command for turning on a television (TV), (2) a command for raising the volume of the TV, (3) a command for changing an equalizer of the TV to a movie mode, and (4) a command for executing the Netflix application (app) to be executed in sequential order. In this example, to change to the Netflix viewing mode, which is a user’s intent, it may be convenient to sequentially or simultaneously execute a plurality of commands (e.g., preconditions) beforehand.

However, after executing the foregoing commands, reversing to the original state may be difficult. For example, after viewing Netflix, restoring a changed state to a previous state before viewing Netflix on the TV (e.g., end the Netflix app → change the equalizer to a standard mode → set the TV volume to a previous state → turn off the TV) may not be simple, requiring a user to perform all these. For example, although (1) the command for turning on the TV, (2) the command for raising the volume of the TV, and (3) the command for changing the equalizer of the TV to the movie mode are executed sequentially in response to the voice input “Change to the Netflix viewing mode,” the Netflix app is not available to use and (4) the command for running the Netflix app is not executed, the user may still be responsible for restoring the state to the previous state of the TV (e.g., change the equalizer to the standard mode → set the TV volume to the previous state → turn off the TV). The state changed by the voice input may be different from the previous state which is a state before a command according to the voice input is executed.

Therefore, it would be desirably to automatically restore a state of an electronic device changed all at once or in set order by a voice input to a previous state which is a state before a command is executed according to the voice input.

An aspect of certain embodiments of the present disclosure provides a technology for automatically restoring a state of an electronic device changed all at once or in set order by a user’s utterance (e.g., a voice command) to a previous state of the electronic device.

However, technical aspects are not limited to the foregoing aspect, and other technical aspects may also be present. Additional aspects of the embodiments of the disclosure will be set forth in part in the description with follows and, in part, will be apparent from the description, or may be learned by practice of the disclosure.

According to an embodiment, an electronic device, comprising: a memory configured to store instructions; and a processor electrically connected to the memory and configured to execute the instructions, wherein, when the instructions are executed by the processor, the processor performs a plurality of operations, the plurality of operations comprising: when a first utterance from a user is a command for a target device, obtaining state information for an original state of the target device; and generating reverse voice metadata for the target device to revert to the original state from a post-utterance state of the target device based on the state information on the original state, wherein the original state is a state of the target device before being changed by the first utterance, and the post-utterance state is a state of the target device changed by the first utterance.

According to an embodiment, an operation method of an electronic device, comprises: when a first utterance from a user is a command for a target device, obtaining state information for an original state of the target device; and generating reverse voice metadata for the target device to revert to the original state from a post-utterance state of the target device based on the state information on the original state, wherein the original state is a state of the target device before being changed by the first utterance, and the post-utterance state is a state of the target device changed by the first utterance.

According to certain embodiments described herein, restoring a state of an electronic device changed by an utterance from a user to a previous state prior to the change by the utterance may provide convenience to the user.

Other features and aspects will be apparent from the following detailed description, the drawings, and the claims.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram illustrating an example electronic device in a network environment according to an embodiment;

FIG. 2 is a block diagram illustrating an example integrated intelligence system according to an embodiment;

FIG. 3 is a diagram illustrating an example form in which concept and action relationship information is stored in a database (DB) according to an embodiment;

FIG. 4 is a diagram illustrating example screens showing an electronic device processing a received voice input through an intelligent application (app) according to an embodiment;

FIG. 5 is a diagram illustrating a concept of restoring a device state of a target device to a previous state of the target device after changing the device state according to a user’s utterance according to an embodiment;

FIG. 6 is a diagram illustrating an example voice assistant system according to an embodiment;

FIGS. 7A and 7B are diagrams illustrating example operations of an intent handler module according to an embodiment;

FIG. 8 is a diagram illustrating an example intent hander module according to an embodiment;

FIGS. 9A and 9B are diagrams illustrating example operations of a device state snapshot module according to an embodiment;

FIG. 10 is a flowchart illustrating an example operation method of an electronic device according to an embodiment;

FIGS. 11A and 11B are diagrams illustrating an example operation of controlling a target device according to a user’s utterance according to an embodiment;

FIGS. 12A and 12B are diagrams illustrating another example operation of controlling a target device according to a user’s utterance according to an embodiment; and

FIGS. 13A and 13B are diagrams illustrating still another example operation of controlling a target device according to a user’s utterance according to an embodiment.

### DETAILED DESCRIPTION

Hereinafter, certain example embodiments will be described in greater detail with reference to the accompanying drawings. When describing the example embodiments with reference to the accompanying drawings, like reference numerals refer to like elements and a repeated description related thereto will be omitted.

Certain embodiments in this disclosure include an electronic device and method for reverting back to an original state of the target device after performing commands following a user utterance. The original state is the state of the target device immediately prior to the user utterance. After performing the commands to effectuate the user utterance, the target device may revert to its original state.

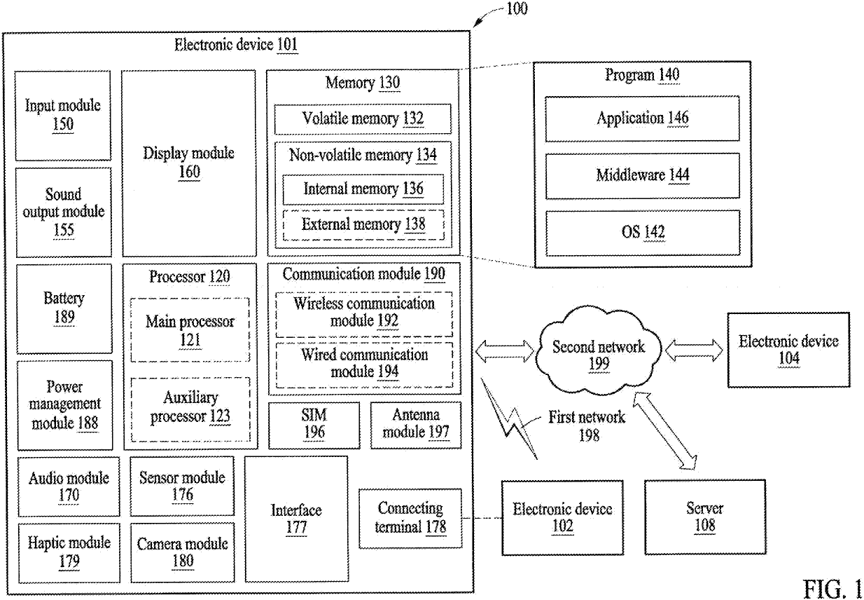

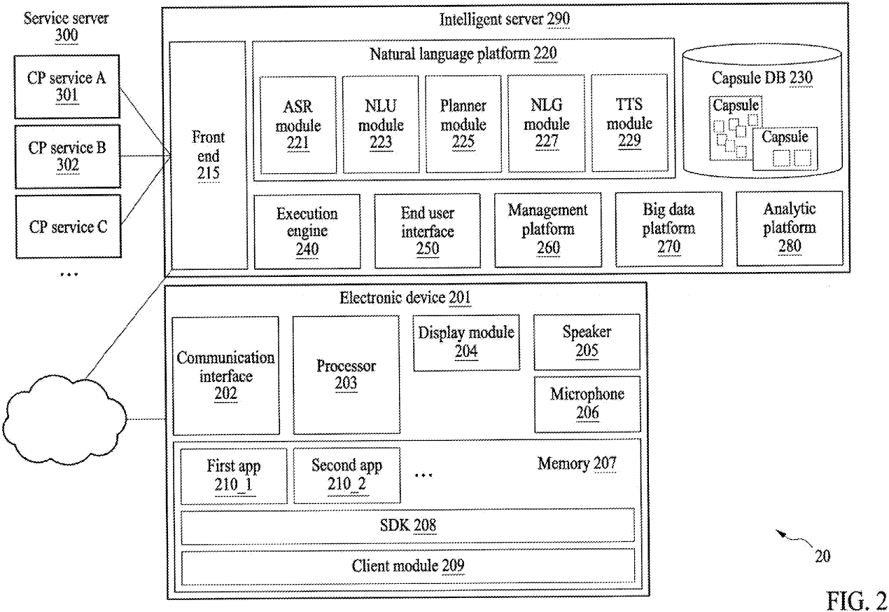

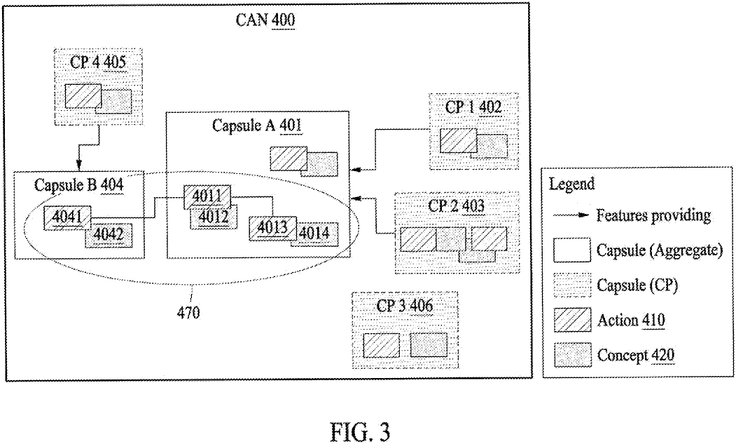

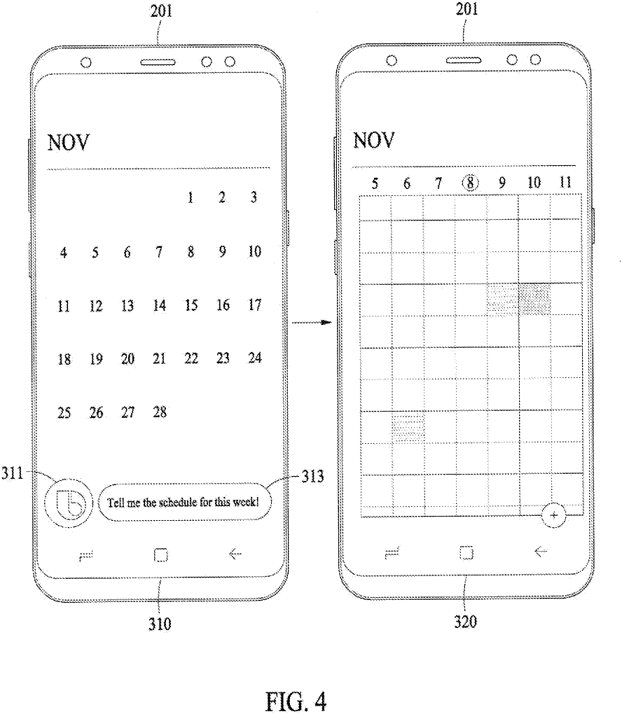

FIG. 1 describes an electronic device where certain embodiments of the disclosure can be practiced. FIG. 2 describes the electronic device integrated into an intelligence system, wherein a user utterance or a text input can be converted into a commands indicative of the user’s intent. FIG. 3 describes a capsule database of the intelligence system. FIG. 4 describes a user interface for an intelligent app.

### Electronic Device

FIG. 1 is a block diagram illustrating one example of an electronic device in a network environment according to certain embodiments. It shall be understood electronic devices are not limited to the following, may omit certain components, and may add other components. Referring to FIG. 1, an electronic device 101 in a network environment 100 may communicate with an electronic device 102 via a first network 198 (e.g., a short-range wireless communication network), or communicate with at least one of an electronic device 104 and a server 108 via a second network 199 (e.g., a long-range wireless communication network). The electronic device 101 may communicate with the electronic device 104 via the server 108. The electronic device 101 may include a processor 120, a memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one (e.g., the connecting terminal 178) of the above components may be omitted from the electronic device 101, or one or more other components may be added to the electronic device 101. In some embodiments, some (e.g., the sensor module 176, the camera module 180, or the antenna module 197) of the components may be integrated as a single component (e.g., the display module 160).

The processor 120 may execute, for example, software (e.g., a program 140) to control at least one other component (e.g., a hardware or software component) of the electronic device 101 connected to the processor 120, and may perform various data processing or computation. According to an embodiment, as at least a part of data processing or computation, the processor 120 may store a command or data received from another component (e.g., the sensor module 176 or the communication module 190) in a volatile memory 132, process the command or data stored in the volatile memory 132, and store resulting data in a non-volatile memory 134. The processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently from or in conj unction with, the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121. The term “processor” shall be understood to refer to both the singular and plural contexts.

The auxiliary processor 123 may control at least some of functions or states related to at least one (e.g., the display device 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). The auxiliary processor 123 (e.g., an ISP or a CP) may be implemented as a portion of another component (e.g., the camera module 180 or the communication module 190) that is functionally related to the auxiliary processor 123. The auxiliary processor 123 (e.g., an NPU) may include a hardware structure specifically for artificial intelligence (AI) model processing. An AI model may be generated by machine learning. The learning may be performed by, for example, the electronic device 101, in which the AI model is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The AI model may alternatively or additionally include a software structure other than the hardware structure.

The memory 130 may store various pieces of data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134. The non-volatile memory 134 may include an internal memory 136 and an external memory 138.

The program 140 may be stored as software in the memory 130 and may include, for example, an operating system (OS) 142, middleware 144, or an application 146.

The input module 150 may receive, from outside (e.g., a user) the electronic device 101, a command or data to be used by another component (e.g., the processor 120) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing a recording. The receiver may be used to receive an incoming call. The receiver may be implemented separately from the speaker or as a part of the speaker.

The display module 160 may visually provide information to the outside (e.g., a user) of the electronic device 101. The display module 160 may include, for example, a display, a hologram device, or a projector, and a control circuitry to control its corresponding one of the display, the hologram device, and the projector. The display module 160 may include a touch sensor adapted to sense a touch, or a pressure sensor adapted to measure an intensity of a force of the touch.

The audio module 170 may convert sound into an electric signal or vice versa. The audio module 170 may obtain the sound via the input module 150 or output the sound via the sound output module 155 or an external electronic device (e.g., the electronic device 102, such as a speaker or headphones) directly or wirelessly connected to the electronic device 101.

The sensor module 176 may detect an operational state (e.g., power or temperature) of the electronic device 101 or an environmental state (e.g., a state of a user) external to the electronic device 101 and generate an electric signal or data value corresponding to the detected state. The sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used by the electronic device 101 to couple with an external electronic device (e.g., the electronic device 102) directly (e.g., by wire) or wirelessly. The interface 177 may include, for example, a high-definition multimedia interface (HDMI), a universal serial bus (USB) interface, a secure digital (SD) card interface, or an audio interface.

The connecting terminal 178 may include a connector via which the electronic device 101 may physically connect to an external electronic device (e.g., the electronic device 102). The connecting terminal 178 may include, for example, an HDMI connector, a USB connector, an SD card connector, or an audio connector (e.g., a headphones connector).

The haptic module 179 may convert an electric signal into a mechanical stimulus (e.g., a vibration or a movement) or an electrical stimulus, which may be recognized by a user via their tactile sensation or kinesthetic sensation. The haptic module 179 may include, for example, a motor, a piezoelectric element, or an electric stimulator.

The camera module 180 may capture a still image and moving images. The camera module 180 may include one or more lenses, image sensors, ISPs, and flashes.

The power management module 188 may manage power supplied to the electronic device 101. The power management module 188 may be implemented as, for example, at least a part of a power management integrated circuit (PMIC).

The battery 189 may supply power to at least one component of the electronic device 101. The battery 189 may include, for example, a primary cell, which is not rechargeable, a secondary cell, which is rechargeable, or a fuel cell.

The communication module 190 may support establishing a direct (e.g., wired) communication channel or a wireless communication channel between the electronic device 101 and an external electronic device (e.g., the electronic device 102, the electronic device 104, or the server 108) and performing communication via the established communication channel. The communication module 190 may include one or more CPs that are operable independently from the processor 120 (e.g., an AP) and that support direct (e.g., wired) communication or wireless communication. The communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device, for example, the electronic device 104, via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and a next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beamforming, or a large-scale antenna. The wireless communication module 192 may support various requirements specified in the electronic device 101, an external electronic device (e.g., the electronic device 104), or a network system (e.g., the second network 199). The wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., an external electronic device) of the electronic device 101. The antenna module 197 may include an antenna including a radiating element including a conductive material or a conductive pattern formed in or on a substrate (e.g., a printed circuit board (PCB)). The antenna module 197 may include a plurality of antennas (e.g., an antenna array). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to an embodiment, another component (e.g., a radio frequency integrated circuit (RFIC)) other than the radiating element may be additionally formed as a part of the antenna module 197.

The antenna module 197 may form a mmWave antenna module. The mmWave antenna module may include a PCB, an RFIC on a first surface (e.g., a bottom surface) of the PCB or adjacent to the first surface of the PCB and capable of supporting a designated high-frequency band (e.g., a mmWave band), and a plurality of antennas (e.g., an antenna array) disposed on a second surface (e.g., a top or a side surface) of the PCB, or adj acent to the second surface of the PCB and capable of transmitting or receiving signals in the designated high-frequency band.

At least some of the above-described components may be coupled mutually and exchange signals (e.g., commands or data) therebetween via an inter-peripheral communication scheme (e.g., a bus, general-purpose input and output (GPIO), serial peripheral interface (SPI), or mobile industry processor interface (MIPI)).

Commands or data may be transmitted or received between the electronic device 101 and the external electronic device (e.g., the electronic device 104) via the server 108 coupled with the second network 199. Each of the external electronic devices (e.g., the electronic device 102 or 104) may be a device of the same type as or a different type from the electronic device 101. All or some of operations to be executed by the electronic device 101 may be executed by one or more of the external electronic devices (e.g., the electronic devices 102 and 104 and the server 108). For example, if the electronic device 101 needs to perform a function or a service automatically, or in response to a request from a user or another device, the electronic device 101, instead of, or in addition to, executing the function or service, may request one or more external electronic devices to perform at least a part of the function or service. The one or more external electronic devices receiving the request may perform the at least part of the function or the service requested, or an additional function or an additional service related to the request and may transfer a result of the performance to the electronic device 101. The electronic device 101 may provide the result, with or without further processing of the result, as at least part of a response to the request. To that end, cloud computing, distributed computing, mobile edge computing (MEC), or client-server computing technology may be used, for example. The electronic device 101 may provide ultra-low latency services using, e.g., distributed computing or MEC. In an embodiment, the external electronic device (e.g., the electronic device 104) may include an Internet-of-things (IoT) device. The server 108 may be an intelligent server using machine learning and/or a neural network. The external electronic device (e.g., the electronic device 104) or the server 108 may be included in the second network 199. The electronic device 101 may be applied to intelligent services (e.g., a smart home, a smart city, a smart car, or healthcare) based on 5G communication technology or IoT-related technology.

An electronic device may be a device of one of various types. The electronic device may include, as non-limiting examples, a portable communication device (e.g., a smartphone, etc.), a computing device, a portable multimedia device, a portable medical device, a camera, a wearable device, or a home appliance. However, the electronic device is not limited to the foregoing examples.

It should be understood that certain embodiments of the present disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things unless the relevant context clearly indicates otherwise. As used herein, “A or B”, “at least one of A and B”, “at least one of A or B”, “A, B or C”, “at least one of A, B and C”, and “A, B, or C,” each of which may include any one of the items listed together in the corresponding one of the phrases, or all possible combinations thereof. Terms such as “first”, “second”, or “first” or “second” may simply be used to distinguish the component from other components in question, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., by wire), wirelessly, or via a third element.

As used in connection with certain embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in the form of an application-specific integrated circuit (ASIC).

Certain embodiments as set forth herein may be implemented as software (e.g., the program 140) including one or more instructions that are stored in a storage medium (e.g., the internal memory 136 or the external memory 138) that is readable by a machine (e.g., the electronic device 101). For example, a processor (e.g., the processor 120) of the machine (e.g., the electronic device 101) may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an example embodiment, a method according to certain embodiments of the disclosure may be included and provided in a computer program product. The computer program product may be traded as a product between a seller and a buyer. The computer program product may be distributed in the form of a machine-readable storage medium (e.g., a compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as a memory of the manufacturer’s server, a server of the application store, or a relay server.

According to certain embodiments, each component (e.g., a module or a program) of the above-described components may include a single entity or multiple entities, and some of the multiple entities may be separately disposed in different components. According to certain embodiments, one or more of the above-described components may be omitted, or one or more other components may be added. Alternatively or additionally, a plurality of components (e.g., modules or programs) may be integrated into a single component. In such a case, according to certain embodiments, the integrated component may still perform one or more functions of each of the plurality of components in the same or similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

The electronic device 101 can include a microphone in the audio module 170. The user can give a user utterance, with a request for a desired task. The microphone can provide an electronic signal of the user’s utterance that can then get converted to text. From the text, the electronic device 101 can determine an appropriate set of commands to effectuate the user’s request. The user can also indicate a request using a text entry that is written in natural language form. In either case, the user’s intent can be determined from text or the user utterance that is converted to text. FIG. 2 describes an integrated intelligence system that generates a plan including actions that effectuate the user’s requested task.

### Integrated Intelligence System

FIG. 2 is a block diagram illustrating an example integrated intelligence system according to an embodiment. The integrated intelligence system includes an electronic device 201 that is configured to receive a user utterance or a text input, an intelligence server 290 configured to provide a plan including actions to the electronic device 201, and a service server 300 that includes

Referring to FIG. 2, according to an example embodiment, an integrated intelligent system 20 may include an electronic device 201 (e.g., the electronic device 101 of FIG. 1), an intelligent server 290 (e.g., the server 108 of FIG. 1), and a service server 300 (e.g., the server 108 of FIG. 1).

The electronic device 201 may be a terminal device that is connectable to the Internet, for example, a mobile phone, a smartphone, a personal digital assistant (PDA), a laptop computer, a television (TV), a white home appliance, a wearable device, a head-mounted display (HMD), or a smart speaker.

As illustrated, the electronic device 201 may include a communication interface 202 (e.g., the interface 177 of FIG. 1), a microphone 206 (e.g., the input module 150 of FIG. 1), a speaker 205 (e.g., the sound output module 155 of FIG. 1), a display module 204 (e.g., the display module 160 of FIG. 1), a memory 207 (e.g., the memory 130 of FIG. 1), or a processor 203 (e.g., the processor 120 of FIG. 1). The components listed above may be operationally or electrically connected to each other.

The communication interface 202 may be connected to an external device to transmit and receive data to and from the external device. The microphone 206 may receive sound (e.g., an utterance from a user) and convert the sound into an electrical signal. The speaker 205 may output the electrical signal as sound (e.g., voice).

The display module 204 may display an image or video. The display module 204 may also display a graphical user interface (GUI) of an application (app) (or an application program) being executed. The display module 204 may receive a touch input through a touch sensor. For example, the display module 204 may receive a text input through the touch sensor in an on-screen keyboard area displayed on the display module 204.

The memory 207 may store therein a client module 209, a software development kit (SDK) 208, and a plurality of apps 210. The client module 209 and the SDK 208 may configure a framework (or a solution program) for performing general-purpose functions. In addition, the client module 209 or the SDK 208 may configure a framework for processing a user input (e.g., a voice input, a text input, and a touch input).

The apps 210 stored in the memory 207 may be programs for performing predetermined functions. The apps 210 may include a first app 210_1, a second app 210_2, and the like. The apps 210 may each include a plurality of actions for performing the predetermined functions. For example, the apps 210 may include an alarm app, a messaging app, and/or a scheduling app. The apps 210 may be executed by the processor 203 to sequentially execute at least a portion of the actions.

The processor 203 may control the overall operation of electronic device 201. For example, the processor 203 may be electrically connected to the communication interface 202, the microphone 206, the speaker 205, and the display module 204 to perform predetermined operations.

The processor 203 may also perform a predetermined function by executing a program stored in the memory 207. For example, the processor 203 may execute at least one of the client module 209 or the SDK 208 to perform the following operations for processing a user input. For example, the processor 203 may control the actions of the apps 210 through the SDK 208. The following operations described as operations of the client module 209 or the SDK 208 may be operations to be performed by the execution of the processor 203.

The client module 209 may receive a user input. For example, the client module 209 may receive a voice signal corresponding to a user’s utterance sensed through the microphone 206. Alternatively, the client module 209 may receive a touch input sensed through the display module 204. Alternatively, the client module 209 may receive a text input sensed through a keyboard or an on-screen keyboard. The client module 209 may also receive, as non-limiting examples, various types of user inputs sensed through an input module included in the electronic device 201 or an input module connected to the electronic device 201. The client module 209 may transmit the received user input to the intelligent server 290. The client module 209 may transmit, to the intelligent server 290, state information of the electronic device 201 along with the received user input. The state information may be, for example, app execution state information indicating a state of execution of an app.

The client module 209 may also receive a result corresponding to the received user input. For example, when the intelligent server 290 calculates the result corresponding to the received user input, the client module 209 may receive the result corresponding to the received user input. The client module 209 may display the received result on the display module 204 and output the received result in audio through the speaker 205.

The client module 209 may receive a plan corresponding to the received user input. The client module 209 may display, on the display module 204, the results of executing a plurality of actions of an app according to the plan. For example, the client module 209 may sequentially display the results of executing the actions on the display module 204 and output the results in audio through the speaker 205. For another example, electronic device 201 may display only a result of executing a portion of the actions (e.g., a result of executing the last action) on the display module 204 and output the result in audio through the speaker 205.

The client module 209 may receive, from the intelligent server 290, a request for information required to calculate the result corresponding to the user input. The client module 209 may transmit the required information to the intelligent server 290 in response to the request.

The client module 209 may transmit information on the results of executing the actions according to the plan to the intelligent server 290. The intelligent server 290 may verify that the received user input has been correctly processed using the information.

The client module 209 may include a voice recognition module. The client module 209 may recognize a voice input for performing a limited function through the voice recognition module. For example, the client module 209 may execute an intelligent app for processing a voice input to perform an organic action through a set input (e.g., Wake up!).

The intelligent server 290 may receive information related to a user’s voice input from the electronic device 201 through a communication network. The intelligent server 290 may change data related to the received voice input into text data. The intelligent server 290 may generate a plan for performing a task corresponding to the voice input based on the text data.

The plan may be generated by an artificial intelligence (AI) system. The AI system may be a rule-based system or a neural network-based system (e.g., a feedforward neural network (FNN) or a recurrent neural network (RNN)). Alternatively, the AI system may be a combination thereof or another AI system. The plan may be selected from a set of predefined plans or may be generated in real time in response to a request from a user. For example, the AI system may select at least one plan from among the predefined plans.

The intelligent server 290 may transmit a result according to the generated plan to the electronic device 201 or transmit the generated plan to the electronic device 201. The electronic device 201 may display the result according to the plan on the display module 204. The electronic device 201 may display, on the display module 204, a result of executing an action according to the plan.

The intelligent server 290 may include a front end 215, a natural language platform 220, a capsule database (DB) 230, an execution engine 240, an end user interface 250, a management platform 260, a big data platform 270, or an analytic platform 280.

The front end 215 may receive a user input from the electronic device 201. The front end 215 may transmit a response corresponding to the user input.

The natural language platform 220 may include an automatic speech recognition (ASR) module 221, a natural language understanding (NLU) module 223, a planner module 225, a natural language generator (NLG) module 227, or a text-to-speech (TTS) module 229.

The ASR module 221 may convert a voice input received from the electronic device 201 into text data. The NLU module 223 may understand a user’s intention (or intent herein) using the text data of the voice input. For example, the NLU module 223 may understand the user’s intent by performing a syntactic or semantic analysis on a user input in the form of text data. The NLU module 223 may understand semantics of a word extracted from the user input using a linguistic feature (e.g., a syntactic element) of a morpheme or phrase and determine the intent by matching the semantics of the word to the intent.

The planner module 225 may generate a plan using the intent determined by the NLU module 223 and a parameter. The planner module 225 may determine a plurality of domains required to perform a task based on the determined intent. The planner module 225 may determine a plurality of actions included in each of the domains determined based on the intent. The planner module 225 may determine a parameter required to execute the determined actions or a resulting value output by the execution of the actions. The parameter and the resulting value may be defined as a concept of a predetermined form (or class). Accordingly, a plan may include a plurality of actions and a plurality of concepts determined by a user’s intent. The planner module 225 may determine a relationship between the actions and the concepts stepwise (or hierarchically). For example, the planner module 225 may determine an order of executing the actions determined based on the user’s intent, based on the concepts. That is, the planner module 225 may determine the order of executing the actions based on the parameter required for the execution of the actions and the result output by the execution of the actions. Accordingly, the planner module 225 may generate the plan including connection information (e.g., ontology) between the actions and the concepts. The planner module 225 may generate a plan using information stored in the capsule DB 230 that stores therein a set of relationships between concepts and actions.

The NLG module 227 may change predetermined information into a text form. The information changed into the text form may be provided in the form of an utterance in a natural language. The TTS module 229 may change the information in the text form into information in a voice (or speech) form.

According to an embodiment, all or some of the functions of the natural language platform 220 may also be implemented in the electronic device 201.

The capsule DB 230 may store therein information associated with relationships between a plurality of concepts and a plurality of actions corresponding to a plurality of domains. A capsule described herein may include a plurality of action objects (or action information) and concept objects (or concept information) included in a plan. The capsule DB 230 may store a plurality of capsules in the form of a concept-action network (CAN). The capsules may be stored in a function registry included in the capsule DB 230.

The capsule DB 230 may include a strategy registry that stores therein strategy information required to determine a plan corresponding to a user input (e.g., a voice input). When there are a plurality of plans corresponding to the user input, the strategy information may include reference information for determining a single plan. The capsule DB 230 may include a follow-up registry that stores therein information associated with follow-up actions for suggesting a follow-up action to a user in a corresponding predetermined situation. The follow-up action may include, for example, a follow-up utterance (or a subsequent utterance herein). The capsule DB 230 may include a layout registry that stores therein layout information associated with a layout of information output through the electronic device 201. The capsule DB 230 may include a vocabulary registry that stores therein vocabulary information included in capsule information. The capsule DB 230 may include a dialog registry that stores therein information associated with a dialog (or an interaction) with a user. The capsule DB 230 may update the stored objects through a developer tool. The developer tool may include, for example, a function editor for updating an action object or a concept object. The developer tool may include a vocabulary editor for updating a vocabulary. The developer tool may include a strategy editor for generating and registering a strategy for determining a plan. The developer tool may include a dialog editor for generating a dialog with a user. The developer tool may include a follow-up editor for activating a follow-up objective and editing a follow-up utterance that provides a hint. The follow-up objective may be determined based on a currently set objective, a user’s preference, or an environmental condition. The capsule DB 230 may also be implemented in the electronic device 201.

The execution engine 240 may calculate a result using a generated plan. The end user interface 250 may transmit the calculated result to the electronic device 201. Accordingly, the electronic device 201 may receive the result and provide the received result to a user. The management platform 260 may manage information used by the intelligent server 290. The big data platform 270 may collect data of the user. The analytic platform 280 may manage a quality of service (QoS) of the intelligent server 290. For example, the analytic platform 280 may manage the components and a processing rate (or efficiency) of the intelligent server 290.

The service server 300 may provide a preset service (e.g., food ordering or hotel reservation) to the electronic device 201. The service server 300 may be a server operated by a third party. The service server 300 may provide the intelligent server 290 with information to be used for generating a plan corresponding to a received user input. The provided information may be stored in the capsule DB 230. In addition, the service server 300 may provide the intelligent server 290 with resulting information according to the plan.

In the integrated intelligent system 20 described above, the electronic device 201 may provide various intelligent services to a user in response to a user input from the user. The user input may include, for example, an input made through a physical button, a touch input, or a voice input.

The electronic device 201 may provide a voice recognition service through an intelligent app (or a voice recognition app) stored therein. In this case, the electronic device 201 may recognize an utterance or a voice input received from a user through the microphone 206 and provide the user with a service corresponding to the recognized voice input.

The electronic device 201 may perform a predetermined action alone or together with the intelligent server 290 and/or the service server 300 based on the received voice input. For example, the electronic device 201 may execute an app corresponding to the received voice input and perform the action through the executed app.

When the electronic device 201 provides the service together with the intelligent server 290 and/or the service server 300, the electronic device 201 may detect a user’s utterance using the microphone 206 and generate a signal (or voice data) corresponding to the detected utterance. The electronic device 201 may transmit the voice data to the intelligent server 290 using the communication interface 202.

In response to the voice input received from the electronic device 201, the intelligent server 290 may generate a plan for performing a task corresponding to the voice input or a result of performing an action according to the plan. The plan may include, for example, a plurality of actions for performing the task corresponding to the voice input of the user, and a plurality of concepts related to the actions. The concepts may define parameters input to the execution of the actions or resulting values output by the execution of the actions. The plan may include connection information (e.g., ontology) between the actions and the concepts.

The electronic device 201 may receive a response using the communication interface 202. The electronic device 201 may output a voice signal generated in the electronic device 201 to the outside using the speaker 205, or output an image generated in the electronic device 201 to the outside using the display module 204.

### Capsule Database

FIG. 3 is a diagram illustrating an example form in which concept and action relationship information is stored in a DB according to an embodiment.

A capsule DB (e.g., the capsule DB 230 of FIG. 2) of an intelligent server (e.g., the intelligent server 290 of FIG. 2) may store therein capsules in the form of a concept action network (CAN) 400. The capsule DB may store, in the form of the CAN 400, actions for processing a task corresponding to a voice input of a user and parameters necessary for the actions.

The capsule DB may store a plurality of capsules, for example, a capsule A 401 and a capsule B 404, respectively corresponding to a plurality of domains (e.g., apps). One capsule (e.g., the capsule A 401) may correspond to one domain (e.g., a location (geo) app). In addition, one capsule may correspond to at least one service provider (e.g., CP1 402 or CP2 403) for performing a function for a domain related to the capsule. One capsule may include at least one action 410 and at least one concept 420 for performing a preset function.

A natural language platform (e.g., the natural language platform 220 of FIG. 2) may generate a plan for performing a task corresponding to a received voice input using the capsules stored in the capsule DB. For example, a planner module (e.g., the planner module 225 of FIG. 2) of the natural language platform may generate the plan using the capsules stored in the capsule DB. For example, the planner module may generate a plan 470 using actions 4011 and 4013 and concepts 4012 and 4014 of the capsule A 401 and an action 4041 and a concept 4042 of the capsule B 404.

### Intelligent App User Interface

FIG. 4 is a diagram illustrating example screens showing an electronic device processing a received voice input through an intelligent app according to an embodiment.

The electronic device 201 may execute an intelligent app to process a user input through an intelligent server (e.g., the intelligent server 290 of FIG. 2).

Referring to FIG. 4, on a first screen 310, when recognizing a predetermined voice input (e.g., Wake up!) or receiving an input through a hardware key (e.g., a dedicated hardware key), the electronic device 201 may execute an intelligent app for processing the voice input. For example, the electronic device 201 may execute the intelligent app during the execution of a scheduling app. The electronic device 201 may display an object (e.g., an icon) 311 corresponding to the intelligent app on a display module (e.g., the display module 204 of FIG. 2). The electronic device 201 may receive the voice input corresponding to a user’s utterance. For example, the electronic device 201 may receive a voice input “Tell me the schedule for this week!.” The electronic device 201 may display, on the display module 204, a user interface (UI) 313 (e.g., an input window) of the intelligent app on which text data of the received voice input is displayed.

On a second screen 320, the electronic device 201 may display, on the display module 204, a result corresponding to the received voice input. For example, the electronic device 201 may receive a plan corresponding to the received user input and display, on the display module 204, “schedule for this week” according to the plan. An electronic device can receive a voice input through an intelligent app. In response, the electronic device may perform a series of commands. After performing the series of commands, in certain embodiments, the electronic device can revert to its original state prior to receiving the voice input.

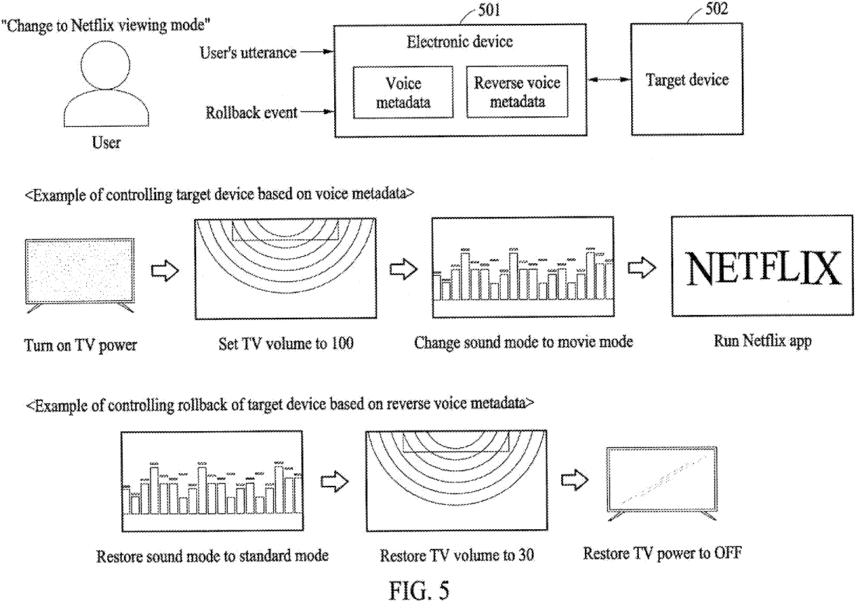

FIG. 5 is a diagram illustrating restoration of a device state of a target device to a previous state of the target device after changing the device state according to a user’s utterance, according to an embodiment.

In response to a user utterance, the electronic device 501 controls the target device 502 to perform according to the utterance using voice metadata. Additionally, the electronic device 501 can generate reverse voice metadata to cause the target device to revert to its original state. The electronic device 501 can generate a file that includes code for effectuating the user’s utterance called voice metadata. The electronic device 501 can also generate a file for reverting the target device to its original state (the state before the user utterance) called reverse voice metadata.

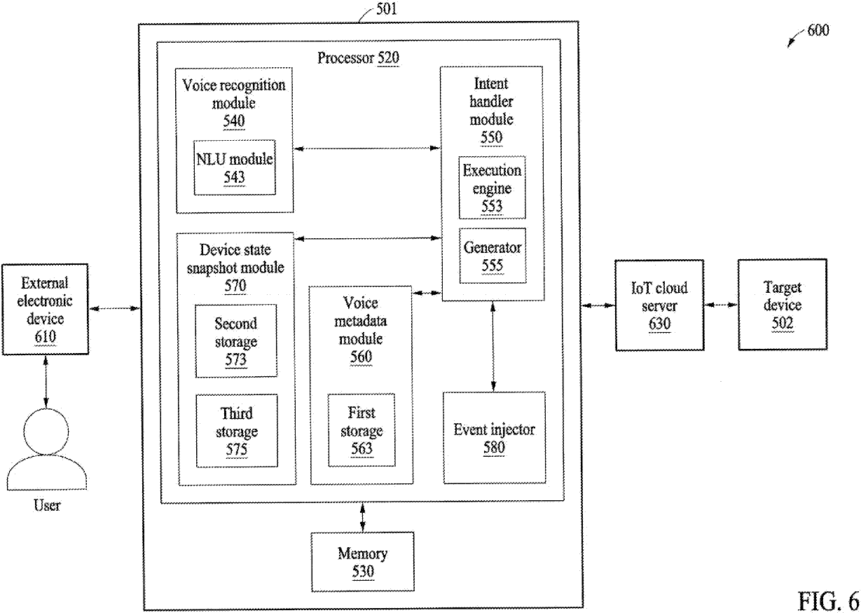

Referring to FIG. 5, according to an embodiment, an electronic device 501 (e.g., the electronic device 101 of FIG. 1, the electronic device 201 of FIG. 2, or the intelligent server 290 of FIG. 2) and a target device 502 may be connected through, for example, a local area network (LAN), a wide area network (WAN), a value-added network (VAN), a mobile radio communication network, a satellite communication network, or a combination thereof. The electronic device 501 and the target device 502 may communicate with each other through wired communication or wireless communication (e.g., wireless LAN (Wi-Fi), Bluetooth, Bluetooth low energy (BLE), ZigBee, or Wi-Fi direct (WFD), ultra-wideband (UWB), infrared data association (IrDA), and near-field communication (NFC)). The electronic device 501 may be connected to the target device 502 through an external device (e.g., a gateway, a relay, or an Internet of things (IoT) cloud server 630 of FIG. 6), or be directly connected to the target device 502.

The devices 501 and 502 may each be implemented as at least one of a smartphone, a tablet personal computer (PC), a mobile phone, a speaker (e.g., an AI speaker), a video phone, an e-book reader, a desktop PC, a laptop PC, a netbook computer, a workstation, a server, a personal digital assistant (PDA), a portable multimedia player (PMP), an MP3 player, a mobile medical device, a camera, or a wearable device. The devices 501 and 502 may also be home appliances. The home appliances may include, for example, a television (TV), a digital video disk (DVD) player, an audio device, a refrigerator, an air conditioner, a vacuum cleaner, an oven, a microwave oven, a washing machine, an air purifier, a set-top box, an automation control panel, a security control panel, a game console, an electronic key, a camcorder, or an electronic picture frame.

The devices 501 and 502 may also be user-owned devices, which are owned by a user. For example, electronic device 501 can be a smartphone, while target device 502 can be a television. A listening device receiving a user’s utterance (e.g., a voice command) may be the electronic device 501 and/or an external electronic device (not shown) (e.g., the electronic device 102 of FIG. 1 or the electronic device 104 of FIG. 1) connected to the electronic device 501. The electronic device 501 may receive a user’s utterance directly from the user and/or through the external electronic device. When the utterance is a device control command (e.g., a remote command for controlling a device, or a remote device control command) for controlling an electronic device other than the electronic device 501, the target device 502, which is a target of the device control command, may be an execution device that executes a command from the user.

When a user’s utterance (e.g., a voice command) is a device control command for the target device 502 to be controlled, the electronic device 501 may control the target device 502 according to the utterance. After controlling the target device 502 according to the utterance, the electronic device 501 may restore a state of the target device 502 to a previous state (e.g., a state before the target device 502 is controlled by the utterance).

The electronic device 501 may receive a user’s utterance (e.g., a first utterance) from a user, and perform voice recognition (e.g., natural language understanding (NLU)) on the received utterance to recognize information of the target device 502 (e.g., including at least one of a type, a name, manufacturer information, or vendor identification (VID) of the target device 502) and a voice intent of the utterance. The voice intent may be represented in a specified format (e.g., JavaScript Object Notation (JSON)). The voice intent may include at least one of voice capability information, voice action information, or parameter information, which are related to an action corresponding to the user’s utterance. The voice intent may be in the form of a character string including the voice capability, voice action, and/or parameter information. For example, the voice capability information may include information indicating a function of a device, the voice action information may include information related to how to operate the function of the device, and the parameter information may include additional information for operating the device. The parameter information may be omitted from the voice intent. Table 1 below shows an example of a voice intent in a case where the target device 502 is a TV, but the voice intent is not necessarily limited thereto.

TABLE 1

| Voice capability | Voice action | Parameter | Description |
|---|---|---|---|
| Powerswitch | ON | None | Power ON |
| Powerswitch | OFF | None | Power OFF |
| Channel | SET | 11 | Channel setting (No. 11) |

The electronic device 501 may change a user intent including the information of the target device 502 and the voice intent to the device control command (e.g., an IoT device command) and transmit the device control command to the target device 502 to control the target device 502. The user intent may also be represented in a specified format (e.g., JSON). The device control command transmitted from the electronic device 501 may be transmitted to the target device 502 directly and/or through an external device (e.g., an IoT hub or the IoT cloud server 630 of FIG. 6) connected to the target device 502. The electronic device 501 may support the target device 502 to execute a single device control command matching the user intent, and support the target device 502 to sequentially execute a plurality of device control commands according to preconditions necessary to execute the device control command matching the user intent. When the target device 502 sequentially executes the device control commands transmitted from the electronic device 501 and the preconditions are thereby satisfied, the target device 502 may then execute the single device control command matching the user intent.

For example, when controlling the target device 502 according to the user’s utterance, the electronic device 501 may use voice metadata related to the user’s utterance. The voice metadata may relate to a device control logic for the target device 502 corresponding to the user’s utterance. The voice metadata may describe an execution path related to an order of executing one or more device control commands for the target device 502 to perform an action corresponding to the user’s utterance. The voice metadata may also describe an execution path related to an order of executing a plurality of device control commands for satisfying the preconditions for the target device 502 required to perform the action corresponding to the user’s utterance.

An example will now be described where the user makes a request to “Change to the Netflix viewing mode.”

When the target device 502 is a TV and a user’s utterance is “Change to the Netflix viewing mode,” there may be preconditions, such as, for example, turning on the TV power, setting the TV volume to a specified volume (e.g., volume 100), and changing a sound mode to a movie mode (e.g., a movie-specific equalizer), for the target device 502 to perform an action of running a Netflix app. The target device 502 may need to satisfy a state corresponding to the preconditions before running the Netflix app. In this example, voice metadata related to the utterance “Change to the Netflix viewing mode” may be a description of an execution path related to an order of sequentially executing (1) a command for tunning on the TV power, (2) a command for setting set the TV volume to a specified volume, (3) a command for changing the sound mode to the movie mode, and (4) a command for running the Netflix app.

The electronic device 501 may recognize the voice metadata related to the user’s utterance based on the user intent. The voice metadata may be a file in a specified format (e.g., a JSON format) configured to be executable by a processor (e.g., a processor 520 of FIG. 6). The file may include code to be executed by the processor to process the user’s utterance. The voice metadata may include the information (e.g., VID, voice capability, and/or voice action information) of the target device 502 to be used. The voice metadata may include, or be configured with, a plurality of nodes, which is the smallest logical unit performing a function.

The electronic device 501 may determine whether there is a precondition for the target device 502 required to perform the action corresponding to the user’s utterance based on the voice metadata. When there is no precondition, the electronic device 501 may directly transmit the device control command to the target device 502 such that the target device 502 performs the action corresponding to the user’s utterance without verifying a state of the target device 502.

When there is a precondition, the electronic device 501 may obtain a state of the target device 502 corresponding to the precondition and determine whether the state of the target device 502 satisfies the precondition. For example, the electronic device 501 may sequentially obtain respective states of the target device 502 corresponding to the preconditions according to the execution path described in the voice metadata and determine whether the states of the target device 502 satisfy the preconditions, respectively. For example, when a state of the target device 502 does not satisfy a corresponding precondition, the electronic device 501 may transmit, to the target device 502, a command for allowing the target device 502 to perform an action corresponding to the precondition that is not satisfied based on the voice metadata. For example, in response to a user’s utterance “Change to the Netflix watching mode,” the electronic device 501 may obtain a state of power of the target device 502 and determine whether a precondition (e.g., turning on the TV) is satisfied. In this example, when the power of the target device 502 is turned off, the electronic device 501 may transmit, to the target device 502, a device control command (e.g., a command for turning on the TV power) corresponding to the precondition. For subsequent preconditions (e.g., setting the TV volume to a specified volume and changing the sound mode to the movie mode), the electronic device 501 may sequentially perform operations in substantially the same way as described above.

When the electronic device 501 needs the target device 502 to perform an operation corresponding to a precondition for the target device 502 to perform the action corresponding to the user’s utterance, the electronic device 501 may allow the target device 502 to perform the operation corresponding to the precondition without an additional input from the user using the voice metadata related to the user’s utterance and then perform the action corresponding to the user’s utterance, thereby smoothly providing a voice assistant service that meets a user’ intent the user desires to achieve.

When the target device 502 is controlled by the user’s utterance, the state (e.g., the device state) of the target device 502 may be changed from an original state (is a state of the target device 502 before being controlled by the user’s utterance). When necessary (e.g., to cancel the execution of a device control command according to the user’s utterance, maintain the device control command according to the user’s utterance only for a predetermined period of time, or when the device control command according to the user’s utterance fails) after controlling the target device 502 according to the user’s utterance, the electronic device 501 may restore the state of the target device 502 to the original state (e.g., a state before the target device 502 is controlled by the user’s utterance). The term “restore” used herein may be construed or also be used as to “roll-back or revert” to a previous state.

The electronic device 501 may generate reverse voice metadata (e.g., rollback voice metadata) of the target device 502 for reverting(or rolling back) the state of the target device 502 changed by the user’s utterance to the original state (e.g., the state before the target device 502 is controlled by the user’s utterance). The electronic device 501 may generate the reverse voice metadata (e.g., the rollback voice metadata) of the target device 502 while controlling the target device 502 using the voice metadata related to the user’s utterance.

The electronic device 501 may obtain state information on an original state of the target device 502 before being changed by the user’s utterance. The electronic device 501 may sequentially obtain respective states of the target device 502 corresponding to preconditions according to an execution path described in the voice metadata while controlling the target device 502 using the voice metadata related to the user’s utterance. In this case, the electronic device 501 may obtain and store, as the state information on the original state, state information of the target device 502 related to one or more conditions that are not satisfied by the target device 502 among the preconditions. For example, when the target device 502 is controlled by a user’s utterance “Change to the Netflix viewing mode,” the electronic device 501 may obtain, as the state information on the original state of the target device 502, state information (e.g., information on a state in which the TV power is off, a state in which the TV volume is 30, and a state in which the sound mode is a standard mode) of the target device 502 related to the conditions that are not satisfied among the preconditions (e.g., turning on the TV power, setting the TV volume to a specified volume, and changing the sound mode to the movie mode) described in the voice metadata related to the user’s utterance “Change to the Netflix viewing mode.”

The electronic device 501 may generate the reverse voice metadata of the target device 502 based on the voice metadata related to the user’s utterance and the state information on the original state of the target device 502. The reverse voice metadata may describe an execution path related to an order of executing one or more device control commands for reverting the state of the target device 502 to the original state which is a state before the target device 502 is controlled by the user’s utterance. A device control command for the reversion, which is also referred to as a reversion command, may be for reverting to state information of the target device 502 related to a condition that is not satisfied among the preconditions described in the voice metadata. Whenever obtaining the state information on the original state of the target device 502, the electronic device 501 may overwrite, in the reverse voice metadata of the target device 502, reverse voice metadata (e.g., a rollback device control command for reverting to the obtained state information) of the obtained state information. The reverse voice metadata may describe, in reverse order, the preconditions described in the voice metadata.

The electronic device 501 may control the target device 502 such that the target device 502 is reverted to the original state from another state of the target device 502 changed by the user’s utterance, based on the reverse voice metadata of the target device 502. The electronic device 501 may sequentially transmit reversion control commands described in the reverse voice metadata to the target device 502.

In response to a reversion event for the target device 502, the electronic device 501 may revert the target device 502 to its original state, using the reverse voice metadata of the target device 502. The reversion event may include at least one of an intent (e.g., a voice intent or a user intent) of the user’s intent, an execution state of the target device 502 according to the user’s utterance, or a subsequent utterance (e.g., a second utterance) after the user’s utterance (e.g., the first utterance).

FIG. 6 is a diagram illustrating an example voice assistant system according to an embodiment. The user may make a user utterance to the external electronic device 610. The external electronic device 610 provides the user utterance to the electronic device 501. A voice recognition module 540 determines a user intent and provides the user intent to an intent handler module 550. A voice metadata module 560 can provide voice metadata for the user utterance to the intent handler module 550. Additionally, the intent handler module 550 may generate the reverse voice metadata including a device control command for reversion to the obtained state information and overwrite the generated reverse voice metadata in the reverse metadata of the target device stored in the snapshot module 570.

Referring to FIG. 6, according to an embodiment, a voice assistant system 600 may include an external electronic device 610 (e.g., the electronic device 102 of FIG. 1 or the electronic device 104 of FIG. 1), the electronic device 501, an IoT cloud server 630 (e.g., the server 108 of FIG. 1), and the target device 502. The external electronic device 610 and the electronic device 501 may be integrally implemented. For example, a single electronic device may control the operation of the external electronic device 610 receiving an utterance from a user and an operation of the electronic device 501 as a voice assistant.

The external electronic device 610 may receive a user’s utterance (e.g., a voice command) through a microphone and transmit the received utterance to the electronic device 501. The external electronic device 610 may obtain a voice signal from the user’s utterance and transmit the voice signal to the electronic device 501. For example, the voice signal may be a computer-readable text into which a voice part of the user’s utterance is converted through automatic speech recognition (ASR) performed by the external electronic device 610 on the user’s utterance. The ASR may also be performed by the electronic device 501.

The electronic device 501 may include at least one processor 520 (e.g., the processor 120 of FIG. 1 or the processor 203 of FIG. 2), and a memory 530 (e.g., the memory 130 of FIG. 1 or the memory 207 of FIG. 2) electrically connected to the processor 520. The electronic device 501 may support a voice assistant (e.g., a voice assistant service (Bixby)). The voice assistant may be configured or supported by one or more of a voice recognition module 540, an intent handler module 550, a voice metadata module 560, a device state snapshot module 570, and an event injector 580 that are included in the electronic device 501. The voice recognition module 540, the intent handler module 550, the voice metadata module 560, the device state snapshot module 570, and the event injector 580 may be executable by the processor 520 and be configured as at least one of a program code including instructions that may be stored in the memory 530, an application, an algorithm, a routine, a set of instructions, or an AI learning model. In addition, at least one of the voice recognition module 540, the intent handler module 550, the voice metadata module 560, the device state snapshot module 570, or the event injector 580 may be implemented by hardware or a combination of hardware and software. In addition, at least some of the voice recognition module 540, the intent handler module 550, the voice metadata module 560, the device state snapshot module 570, and the event injector 580 may be implemented as a separate server or a single integrated server. In addition, at least some of the voice recognition module 540, the intent handler module 550, the voice metadata module 560, the device state snapshot module 570, and the event injector 580 may be integrated and implemented as the processor 520.

The voice recognition module 540 may include an NLU module 543 (e.g., the NLU module 223 of FIG. 2). For example, the voice recognition module 540 may analyze a user’s utterance to recognize information of the target device 502 (e.g., including at least one of a type, a name, manufacturer information, or a VID of the target device 502) and a voice intent. The voice recognition module 540 may output, to the intent handler module 550, a user intent including the information of the target device 502 and the voice intent.

The intent handler module 550 may obtain voice metadata related to the user’s utterance from the voice metadata module 560 based on the user intent. The voice metadata, which is previously generated by a device developer, may include additional information (e.g., the user intent extracted from the utterance) that may not be readily obtainable from the user’s utterance. The intent handler module 550 may determine whether there is a precondition for the target device 502 required to perform an action corresponding to the user’s utterance based on the voice metadata. When there is no precondition, the intent handler module 550 may immediately transmit, to the target device 502, a device control command for the target device 502 to perform the action corresponding to the user’s utterance, without verifying a state of the target device 502. When there is a precondition, the intent handler module 550 may obtain a state of the target device 502 related to the precondition and determine whether the state of the target device 502 satisfies the precondition. The intent handler module 550 may sequentially obtain respective states of the target device 502 corresponding to preconditions according to an execution path described in the voice metadata, and determine whether the states of the target device 502 satisfy the preconditions, respectively. When a state of the target device 502 does not satisfy a precondition, the intent handler module 550 may transmit, to the target device 502, a device control command for controlling the target device 502 to perform an operation corresponding to the precondition that is not satisfied by the target device 502 based on the voice metadata.

The intent handler module 550 may generate reverse voice metadata (e.g., rollback voice metadata) of the target device 502 for reverting the state of the target device 502 changed by the user’s utterance to a previous state (e.g., a state before the target device 502 is controlled by the user’s utterance). The intent handler module 550 may obtain a state of the target device 502 for each precondition in sequential order according to the execution path described in the voice metadata while controlling the target device 502 using the voice metadata. In this case, the intent handler module 550 may obtain, as state information on a first state, state information of the target device 502 related to one or more conditions that are not satisfied by the target device 502 among the preconditions, and generate the reverse voice metadata including a device control command for a rollback to the obtained state information on the first state. The intent handler module 550 may output, to the device state snapshot module 570, the state information on the original state and the reverse voice metadata to store them therein.

Each time obtaining the state information on the original state of the target device 502, the intent handler module 550 may generate the reverse voice metadata including a device control command for a rollback to the obtained state information and overwrite the generated reverse voice metadata in the reverse voice metadata of the target device 502 stored in the device state snapshot module 570. The reverse voice metadata may describe, in reverse order, the preconditions described in the voice metadata.

In response to a reversion event, the intent handler module 550 may retrieve (e.g., obtain) the reverse voice metadata of the target device 502 from the device state snapshot module 570, and control the target device 502 to revert to the original state from a post-utterance state of the target device 502 changed by the user’s utterance based on the reverse voice metadata. The intent handler module 550 may sequentially transmit rollback device control commands that are included (e.g., described) in the reverse voice metadata to the target device 502. The reversion event may include at least one of an intent of the user’s utterance (e.g., a voice intent or a user intent), an execution state of the target device 502 according to the user’s utterance, or a subsequent utterance after the user’s utterance.

The subsequent utterance (e.g., a second utterance) of the user’s utterance (e.g., a first utterance) may be used as the reversion event. When the second utterance is to cancel the execution according to the first utterance, the intent handler module 550 may control the rollback of the target device 502 using the reverse voice metadata of the target device 502 in response to a user intent of the second utterance output from the voice recognition module 540.

The execution state of the target device 502 according to the user’s utterance may be used as the reversion event. The execution state of the target device 502 used as the reversion event may indicate that the target device 502 fails to execute a received device control command according to the user’s utterance. When the target device 502 fails to execute the device control command, such an execution failure (or an execution failure response) may return to the intent handler module 550 by the target device 502 and/or the IoT cloud server 630. In response to the returning execution failure, the intent handler module 550 may control the rollback of the target device 502 using the reverse voice metadata of the target device 502.

The intent (e.g., the voice intent or the user intent) of the user’s utterance may be used as the reversion event. When the intent is to maintain a device control command according to the user’s utterance only for a predetermined period of time (e.g., to maintain the post-utterance state of the target device 502 corresponding to the device control command according to the user’s utterance only for a predetermined period of time), the intent handler module 550 may output the user intent to the event injector 580 while requesting the event injector 580 to call (or invoke), as data, the user intent of the user’s utterance after the predetermined period of time elapses. The event injector 580 may call the voice intent in substantially the same way as that requested by the voice recognition module 540. The event injector 580 may include a flag “Rollback: true” in the user intent to produce substantially the same result as a user’s utterance of canceling a voice command and output it to the intent handler module 550. In response to the call (e.g., the user intent including the flag “Rollback:true)” from the event injector 580 after the predetermined period of time has elapsed, the intent handler module 550 may control the rollback of the target device 502 using the reverse voice metadata of the target device 502.

The intent handler module 550 may recognize the IoT cloud server 630 connected to the target device 502. One or more device control commands transmitted from the intent handler module 550 (e.g., a command for performing an action corresponding to the user’s utterance, a command for performing an operation corresponding to a precondition, and/or a command for a rollback) may be transmitted to the target device 502 directly and/or via the IoT cloud server 630.

The intent handler module 550 may include an execution engine 553 (e.g., a metadata execution engine) and a generator 555 (e.g., a reverse voice metadata generator). The execution engine 553 may include a library module that executes a content of the voice metadata (e.g., code of the voice metadata) at runtime. The intent handler module 550 may use the execution engine 553 to execute the voice metadata and/or the reverse voice metadata at runtime. The intent handler module 550 may also use the generator 555 to generate the reverse voice metadata.

The voice metadata module 560 may include a first storage 563 (e.g., a voice metadata storage). The voice metadata may be previously generated by a device developer and stored in the first storage 563.

The device state snapshot module 570 may include a second storage 573 (e.g., a device state snapshot storage) and a third storage 575 (e.g., a reverse voice metadata storage). The device state snapshot module 570 may store, in the second storage 573, the state information on the original state output from the intent handler module 550 and store, in the third storage 575, the reverse voice metadata of the target device 502 output from the intent handler module 550.

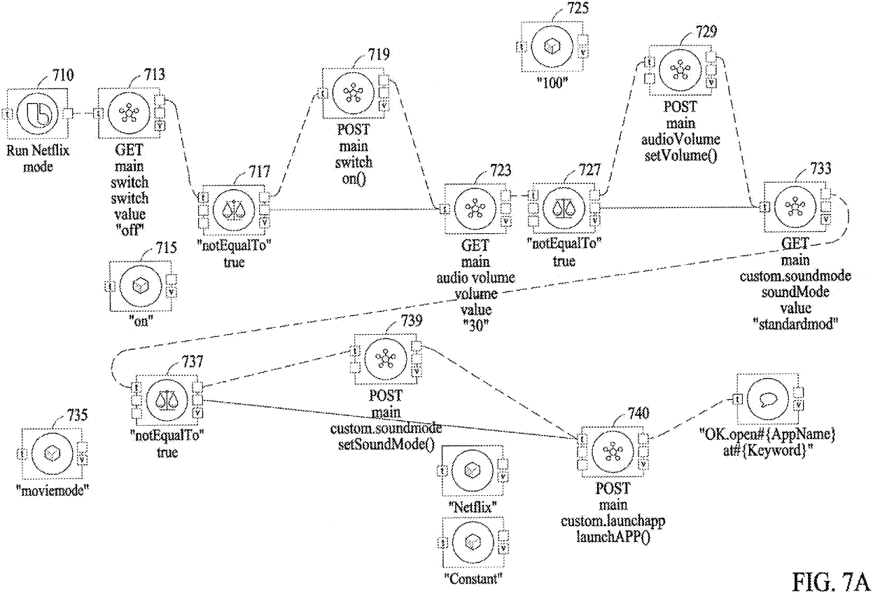

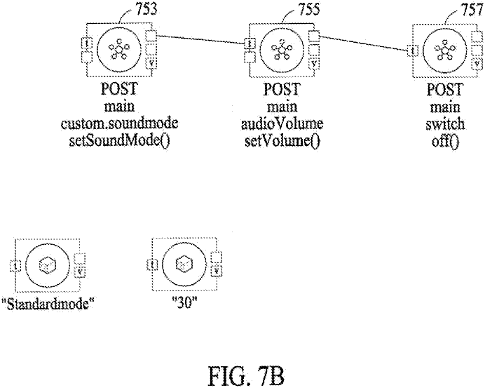

FIGS. 7A and 7B are diagrams illustrating example operations of an intent handler module according to an embodiment. FIG. 7A describes the voice metadata related to a user utterance of “Run Netflix.” The voice metadata describes a system of nodes and branches, that cause the target device in its original state to perform the user utterance, “Run Netflix.” Each node can be a subroutine with associated parameters, while each branch can be based on conditions. FIG. 7B describes reversion of the target device 502 to its original state prior to the user utterance of “Run Netflix.” In some cases, this can include, closing an app., resetting the volume to the volume originally set, and then turning of the display.

FIG. 7A is a diagram illustrating an operation of the intent handler module 550 to control the target device 502 using voice metadata, and FIG. 7B is a diagram illustrating an operation of the intent handler module 550 to generate reverse voice metadata of the target device 502 while controlling the target device 502 using the voice metadata of FIG. 7A. In connection with the voice metadata, terms such as device, capability (different from voice capability), action, VID, voice metadata, and graph may be defined as follows.

According to certain embodiments, the device may refer to a device, such as, for example, an IoT device or a target device. The device may include, for example, an air conditioner, a vacuum cleaner, a lighting, and/or a blind.

The capability may refer to a functional attribute of the device. For example, for volume, a volume capability may be a volume attribute set for a TV, a radio, a speaker, and a mobile device. For channels, a channel capability may be a value used to indicate each broadcast when viewing or listening to n broadcasts is available on a single device. The channel capability may be set for a TV or a radio, but may not be set for a speaker or a mobile device. The capability may be a standardized specification (spec) that does not depend on a specific device. For example, a dimming level capability may be used to indicate the brightness of a lighting or a folding degree of a blind.

A single capability may include n actions. For volume, the capability may include a volume raising action (volume up), a volume lowering action (volume down), and a value setting action (setting a specific value). For channels, the capability may include an action of moving to a next channel (channel up), an action of moving to a previous channel (channel down), and a channel setting action.

The VID may represent a vendor ID. At a point in time at which the voice metadata is executed, an electronic device (e.g., a voice metadata execution engine) may retrieve a VID of a user-owned device based on user information. The VID may be used to identify one specific piece of metadata among pieces of previously stored voice metadata.

The voice metadata may include a JSON text for implementing an execution logic of the device. A single device may use one voice metadata, and one voice metadata may be available on n devices. For example, TVs released at substantially the same time and having the same VID (e.g., VD-STD-2021 VID) may use the same voice metadata corresponding to the VID.

The voice metadata may be configured by a unit of a node which is the smallest logical unit that performs a function. The node may be represented as an object of a specified form on a user interface (UI) (e.g., a voice metadata editor). A start node may be a node that is initially executed at the execution of the voice metadata (e.g., a graph), and a capability command node may be a node that transmits a device control command to the device based on IoT capability specifications.

The graph may be a logical unit that is represented as a linear connection of an execution order of n nodes.

FIG. 7A illustrates an example of voice metadata related to a user’s utterance “Run Netflix (or Netflix mode),” and FIG. 7B illustrates an example of reverse voice metadata generated using the voice metadata of FIG. 7A. FIGS. 7A and 7B illustrate the voice metadata and the reverse voice metadata as node graphs for the convenience of description. A node graph may include branches (e.g., broken-line and solid-line routes) and nodes. A node may be the smallest logical unit that forms metadata (e.g., the voice metadata and the reverse voice metadata). A node may be the smallest logical unit related to the performance of a function. A broken-line route may indicate a route on which a node is executed based on a device state (e.g., a state of the target device 502), and a solid-line route may indicate a route on which a node is not executed. The voice metadata and the reverse voice metadata are not limited to the illustrated node graphs but may be drafted in various ways.

Referring to FIG. 7A, in the node graph illustrated in FIG. 7A, a node (e.g., 710) may be a start node set to correspond to a user’s utterance (e.g., “Run Netflix mode”), a node (e.g., 713, 723, or 733) may be a node set to perform a function of returning a state of the target device 502 (e.g., a TV), a node (e.g., 715, 725, or 735) may be a node setting a constant value to be compared to a return value of the node (e.g., 713, 723, or 733), a node (e.g., 717, 727, or 737) may be a node for determining a branch by comparing the return value of the node (e.g., 712, 723, or 733) and the constant value of the node (e.g., 715, 725, or 735), and a node (e.g., 719, 729, 739, or 740) may be anode set to perform an operation of the target device 502. In order for the target device 502 to perform an action of running the Netflix app, such preconditions as turning on the TV power, setting the TV volume to a specified volume (e.g., volume 100), and changing a sound mode to a specified mode (e.g., a movie mode) may be required. The node (e.g., 717, 727, or 737) may be set to determine whether state information of the target device 502 satisfies a precondition for performing the action corresponding to the user’s utterance. When there is a precondition for performing the action corresponding to the user’s utterance and a device state does not satisfy the precondition, the node (e.g., 719, 729, or 739) may be set to first perform an operation corresponding to the precondition. The node (e.g., 740) may be set to perform the action corresponding to the user’s utterance.

For the convenience of description, it is assumed in an example that the power of the target device 502 is turned off, the volume is set to 30, and the sound mode is set to standard (e.g., a standard mode). In this example, when the electronic device 501 receives a user’s utterance “Run Netflix mode,” the intent handler module 550 may control the target device 502 by verifying a state of the target device 502, and outputting (1) a command for turning on the TV power, (2) a command for setting the TV volume to a specified volume (e.g. volume 100), (3) a command for changing the sound mode (e.g., equalizer) to a specified mode (e.g., a movie mode or a movie-dedicated equalizer), and (4) a command for running the Netflix app in sequential order according to an execution path described in the voice metadata illustrated in FIG. 7A.

The command for turning on the TV power may be executed through a broken-line route on which the nodes 713, 717, and 719 in the voice metadata of FIG. 7A are executed. For example, the node 713 may verify a power state (e.g., an OFF state) of the target device 502 and return a value of OFF. The node 717 may return a value of ‘true’ because the value of the node 713 (e.g., the value of OFF) and a value of the node 715 (e.g., a value of ON) are not the same. When the value of ‘true’ is returned from the node 717, a function of the node 719 may be executed. The node 719 may allow the intent handler module 550 to transmit the command for performing an operation of turning on the power to the target device 502.

The command for setting the TV volume to a specified volume (e.g., volume 100) may be executed through a broken-line route on which the nodes 723, 727, and 729 in the voice metadata of FIG. 7A are executed. For example, the node 723 may verify a volume state of the target device 502 (e.g., volume 30) and return a value of 30. The node 727 may return a value of ‘true’ because the value of the node 723 (e.g., the value of 30) and the value of the node 725 (e.g., the value of 100) are not the same. When the value of ‘true’ is returned from the node 727, a function of the node 729 may be executed. The node 729 may allow the intent handler module 550 to transmit the command for performing an operation of setting (e.g., adjusting) the volume to 100 to the target device 502.

The command for changing the sound mode to a specified mode (e.g., the movie mode) may be executed through a broken-line route on which the nodes 733, 737, and 739 in the voice metadata of FIG. 7A are executed. For example, the node 733 may verify a sound mode state (e.g., the standard mode) of the target device 502 and return a value of the standard mode. The node 737 may return a value of ‘true’ because the value of the node 733 (e.g., the value of the standard mode) and the value of the node 735 (e.g., the value of the movie mode) are not the same. When the value of ‘true’ is returned from the node 737, a function of the node 739 may be executed. The node 739 may allow the intent handler module 550 to transmit the command for performing an operation of setting (e.g., adjusting) the sound mode to the movie mode to the target device 502.

After the command for turning on the TV power, the command for setting the TV volume to a specific volume (e.g., volume 100), and the command for changing the sound mode to a specific mode (e.g., the movie mode) are sequentially executed, the command for running the Netflix app corresponding to the user’s utterance “Run Netflix mode” may be executed through the node 740. The node 740 may allow the intent handler module 550 to transmit the command for performing an operation of running the Netflix app to the target device 502.

Referring to FIG. 7B, in response to a user’s utterance “Run Netflix mode,” the target device 502 may change from a original state in which the power is off, the volume is 30, and the sound mode is a standard mode, to a post-utterance state in which the power is on, the volume is 100, and the sound mode is a movie mode. The intent handler module 550 may generate reverse voice metadata of the target device 502 based on voice metadata related to the user’s utterance and state information on the original state of the target device 502. The reverse voice metadata may include a node 753 that executes a command for reverting the sound mode to a previous mode (e.g., the standard mode), a node 755 that executes a command for reverting the volume to a previous volume (e.g., volume 30), and a node 757 that executes a command for reverting the power to a previous state (e.g., power OFF). The nodes 753, 755, and 757 may be sequentially executed to allow the intent handler module 550 to sequentially transmit, to the target device 502, the command for performing an operation of reverting the sound mode to the standard mode, the command for performing an operation of reverting the volume to 30, and the command for performing an operation of reverting the power state to OFF.

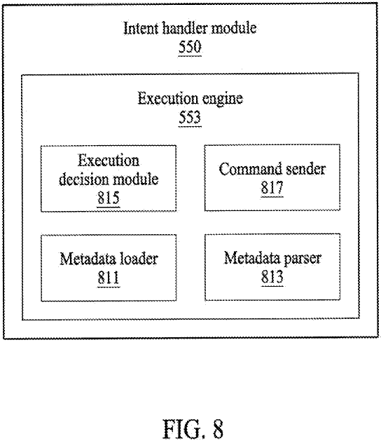

FIG. 8 is a diagram illustrating an example intent handler module according to an embodiment. The intent handler module 550 includes an execution engine 553. The execution engine 553 includes a metadata loader 811 for loading either voice metadata or reverse voice metadata. The metadata parser 813 may divide metadata into objects. The execution decision module 815 executes the nodes of the metadata, and the command sender 817 transmits the commands to the target device.

Referring to FIG. 8, according to an embodiment, the execution engine 553 of the intent handler module 550 may include a voice metadata loader 811, a voice metadata parser 813, an execution decision module 815, and a command sender 817.

The metadata loader 811 may recognize metadata. The metadata loader 811 may recognize voice metadata related to a user’s utterance based on a user intent output from the voice recognition module 540, and may search voice metadata stored in a voice metadata module (e.g., the first storage 563 of FIG. 6) for voice metadata corresponding to information of the target device 502 and obtain the retrieved voice metadata. In addition, in response to a reversion event, the metadata loader 811 may obtain reverse voice metadata of the target device 502 from the third storage 575 (e.g., a reverse voice metadata storage) of the device state snapshot module 570. The metadata (e.g., the voice metadata and the reverse voice metadata) obtained by the metadata loader 811 may be stored in the form of an object (e.g., a JSON file) in a memory of the intent handler module 550. The metadata stored in the form of an object may be accessible by other components included in the execution engine 553.

The metadata parser 813 may divide the metadata into a plurality of objects. The metadata parser 813 may divide metadata stored as one object into a plurality of objects which are smaller units (e.g., nodes). A node may indicate a minimum execution unit of the voice metadata. For example, when the metadata is configured as a single JSON file, a node may indicate a JSON block that is the minimum execution unit of the metadata. The metadata parser 813 may rearrange (or relocate) nodes dividing the metadata according to an execution order. The metadata parser 813 may rearrange the nodes based on the execution order (e.g., information on a node to be executed after a corresponding node) included in each node of the metadata.

The execution decision module 815 may sequentially execute the rearranged nodes (e.g., rearranged JSON blocks) of the metadata. For example, the execution decision module 815 may sequentially execute the rearranged nodes when the metadata is the reverse voice metadata, and determine whether to execute each of the nodes based on a content of each of the rearranged nodes when the metadata is the voice metadata. When the metadata is the voice metadata, the execution decision module 815 may execute a node corresponding to an action corresponding to the user’s utterance (e.g., the user intent), or execute a node corresponding an operation that is a precondition for executing the action corresponding to the user’s utterance (e.g., the user intent). When executing the nodes in sequential order, the execution decision module 815 may determine whether the precondition for executing the action corresponding to the user’s utterance (e.g., the user intent) is satisfied, and determine a subsequent node to be executed subsequently based on a result of the determining.

The command sender 817 may transmit, to the target device 502, a command for controlling the target device 502. The command sender 817 may transmit the command to the target device 502 directly and/or through the IoT cloud server 630 connected to the target device 502. For example, the command sender 817 may extract the command from a node including the command for controlling the target device 502 and transmit the extracted command to the target device 502. The command sender 817 may generate or convert the command in the form of a REST API or RESTful API which stands for a representational state transfer (REST) application programming interface (API) based on the node including the command for controlling the target device 502, and invoke the IoT cloud server 630 connected to the target device 502 and transmit thereto the command for controlling the target device 502.

The configuration of the execution engine 553 is not limited to what is illustrated in FIG. 8, and at least one of the metadata loader 811, the metadata parser 813, the execution decision module 815, or the command sender 817 may be implemented as a single module, or additional components may be included thereto or some of the components may be omitted therefrom.

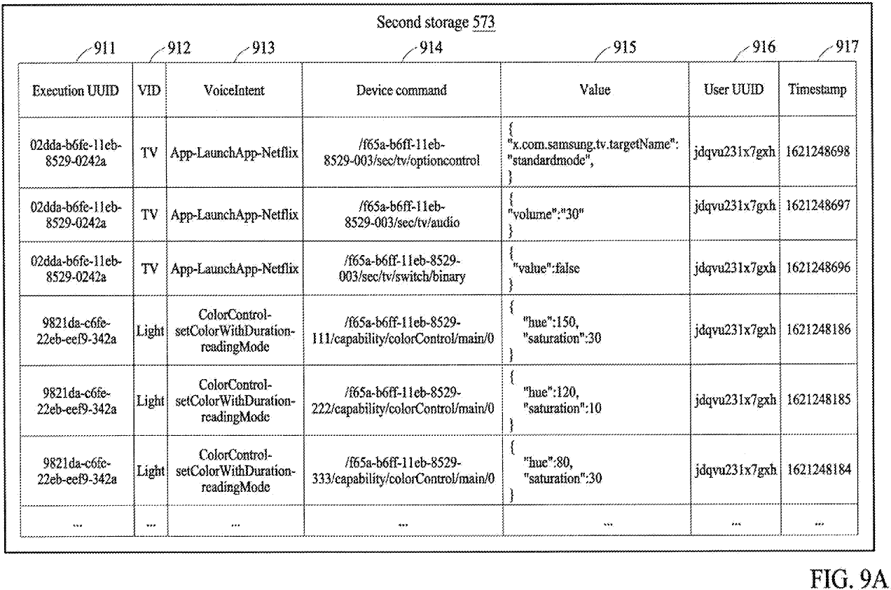

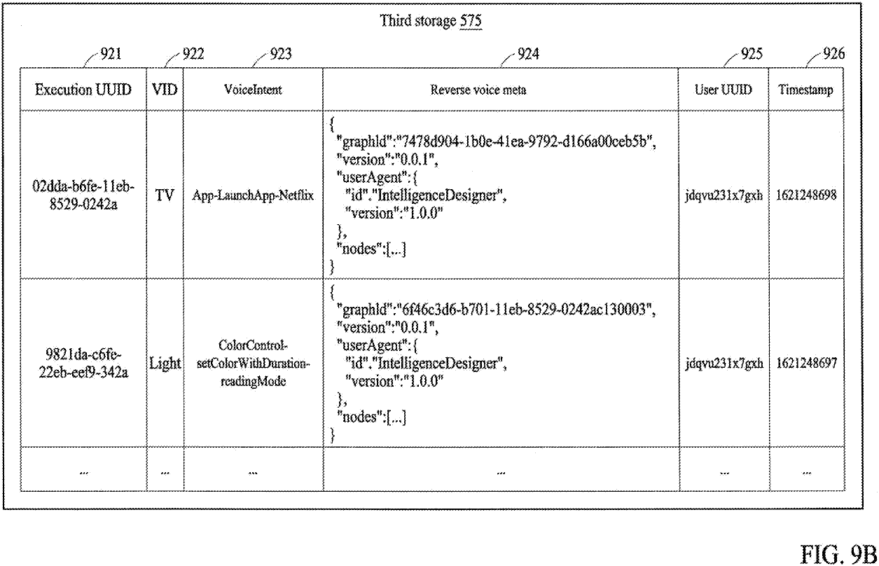

FIGS. 9A and 9B are diagrams illustrating example operations of a device state snapshot module according to an embodiment.

FIG. 9A is a diagram illustrating an operation of the device state snapshot module 570 to store state information of the target device 502 in the second storage 573 (e.g., a device state snapshot storage), and FIG. 9B is a diagram illustrating an operation of the device state snapshot module 570 to store reverse voice metadata of the target device 502.

Referring to FIG. 9A, according to an embodiment, the device state snapshot module 570 may store and manage a state of each device (e.g., the target device 502) of a user (e.g., an individual user) along with time information. For example, the device state snapshot module 570 may store, in the second storage 573, state information on an original state of the target device 502 output from the intent handler module 550 in the form of a table record along with the time information (e.g., a time at which the state information is stored in the second storage 573).

The table record stored in the second storage 573 may include a plurality of fields, such as, for example, Execution UUID 911, VID 912, Voiceintent 913, Device command 914, value 915, User UUID 916, and Timestamp 917. For example, as illustrated, Execution UUID 911 may be a field for storing a unique key for a user’s utterance. Table records having the same value in Execution UUID 911 may indicate data extracted from the same utterance. VID 912 may be a field for storing a type of the target device 502. Voiceintent 913 may be a field for storing user utterance intent information (e.g., a voice intent of a user’s utterance) to be transmitted to the target device 502 or the IoT cloud server 630. Device command 914 may be a field for storing a combination of an ID (e.g., a device ID) of the target device 502 and a device control command URI (or uniform resource identifier) value. For example, in a case of /f65a-b6ff-11eb-8529-003/sec/tv/audio, it may indicate that an audio-related device control command is to be executed for a TV whose Device ID is f65a-b6ff-11eb-8529-003. Value 915 may be a field for storing a current state value of the target device 502 before executing a command stored in Device command 914. For example, in a case of /f65a-b6ff-11eb-8529-003/sec/tv/audio, it may indicate that a current volume of a TV, which is the target device 502, is 30. User UUID 916 may be a field for storing a user’s account ID (or key). Timestamp 917 may be a field for storing a time at which a table record is stored.

According to an embodiment, state information on an original state of the target device 502 may be stored in the second storage 573 in chronological order in which the state information is obtained, in the form of a table record whenever it is stored in the second storage 573. For example, in response to a user’s utterance “Run Netflix (or Netflix mode),” three device control commands (e.g., a command for turning on the TV power ➔ a command for setting the TV volume to a specified volume ➔ a command for changing a sound mode to a specified mode) may be executed, and it may thereby be verified that three table records whose Execution UUID is 02dda-b6fe-11eb-8529-0242a are stored in chronological order in the second storage 573.

Referring to FIG. 9B, according to an embodiment, the device state snapshot module 570 may store and manage reverse voice metadata of each device (e.g., the target device 502) of a user (e.g., an individual user). For example, the device state snapshot module 570 may store, in the third storage 575, the reverse voice metadata of the target device 502 output from the intent handler module 550 in the form of a table record along with time information (e.g., a time at which the reverse voice metadata is stored in the third storage 575).

The table record stored in the third storage 575 may include Execution UUID 921, VID 922, Voiceintent 923, Reverse voice meta 924, User UUID 925, and Timestamp 926. Execution UUID 921 may be a field for storing a unique key for a user’s utterance. Table records having the same value in Execution UUID 921 may indicate data extracted from the same utterance. VID 922 may be a field for storing a type of the target device 502. VoiceIntent 923 may be a field for storing user utterance intent information (e.g., a voice intent of a user’s utterance) to be transmitted to the target device 502 or the IoT cloud server 630. Reverse voice meta 924 may be a field for storing the reverse voice metadata of the target device 502. User UUID 925 may be a field for storing a user’s account ID (or key). Timestamp 926 may be a field for storing a time at which a table record is stored.

The reverse voice metadata of the target device 502 generated by the same utterance may be overwritten in Reverse voice meta 924 to be executed once in response to a reversion event. For example, in response to a user’s utterance “Run Netflix mode,” three device control commands (e.g., a command for turning on the TV power ➔ a command for setting the TV volume to a specified volume ➔ a command for changing a sound mode to a specified mode) may be executed, and it may thereby be verified that the reverse voice metadata is overwritten three times in Reverse voice meta 924 whose Execution UUID is 02dda-b6fe-11eb-8529-0242a.

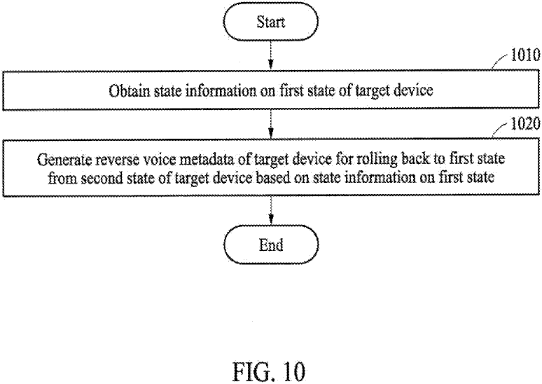

FIG. 10 is a flowchart illustrating an example operation method of an electronic device according to an embodiment.

In operation 1010, when a first utterance (e.g., a voice command) from a user is a device control command for the target device 502 which is a target to be controlled, the electronic device 501 may obtain state information on the original state of the target device 502. The original state may be a state before the target device 502 is changed by the first utterance.

In operation 1020, the electronic device 501 may generate reverse voice metadata of the target device 502 to revert a state of the target device 502 to the original state from a post-utterance state of the target device 502 based on the state information on the first state. The post-utterance state may be a state after the target device 502 is changed by the first utterance.

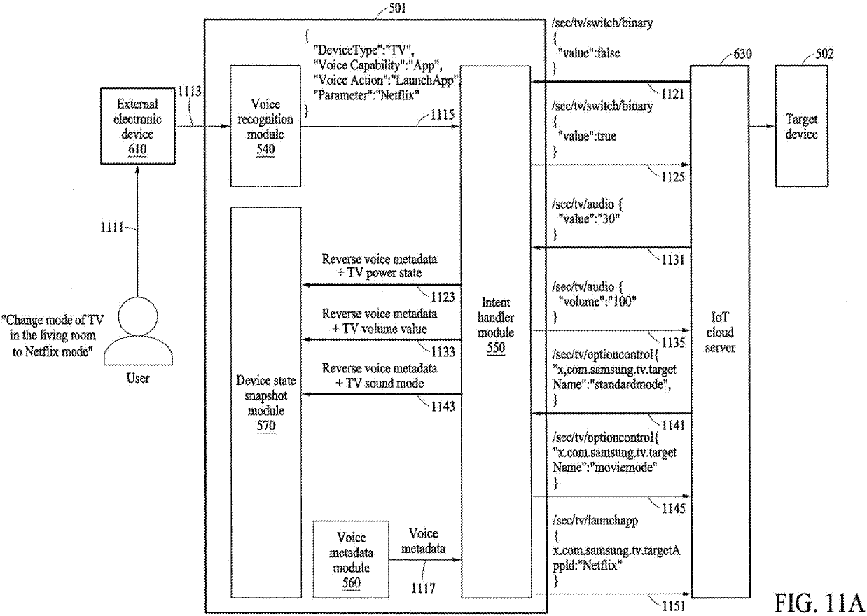

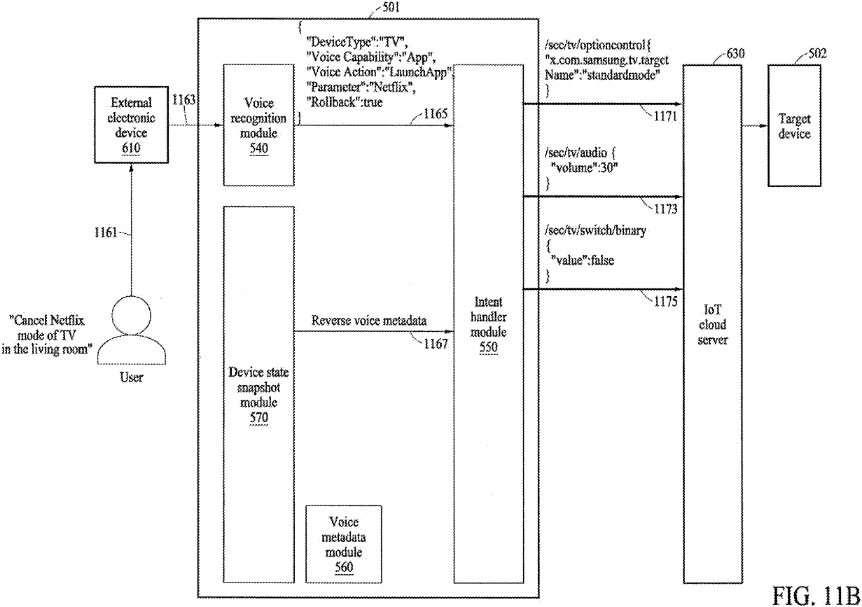

FIGS. 11A and 11B are diagrams illustrating an example operation of controlling a target device according to a user’s utterance according to an embodiment.

FIG. 11A is a diagram illustrating a flow of operations of controlling the target device 502 (e.g., a TV) using voice metadata according to a user’s utterance (e.g., “Change the mode of the TV in the living room to Netflix mode”), and generating reverse voice metadata of the target device 502. Operations 1111 through 1151 to be described hereinafter may be performed in sequential order, but not be necessarily performed in sequential order. For example, operations 1111 through 1151 may be performed in different orders, and at least two of operations 1111 through 1151 may be performed in parallel. For the convenience of description, it is assumed that the power of the target device 502 is turned off, the volume is set to 30, and a sound mode is set to standard (e.g., a standard mode).

In operation 1111, the external electronic device 610 may receive a user’s utterance (e.g., “Change the mode of the TV in the living room to Netflix mode”) through a microphone. The external electronic device 610 may obtain a voice signal from the user’s utterance. In operation 1113, the external electronic device 610 may transmit the voice signal to the electronic device 501.

In operation 1115, the voice recognition module 540 may analyze the user’s utterance, and recognize information (for example, including at least one of a type, a name, manufacturer information, or a VID) of the target device 502 and a voice intent and output, to the intent handler module 550, a user intent including the information of the target device 502 and the voice intent.

In operation 1117, the intent handler module 550 may obtain voice metadata related to the user’s utterance from the voice metadata module 560 based on the user intent. An example of the voice metadata related to the user’s utterance “Change the mode of the TV in the living room to Netflix mode” may be substantially the same as shown in FIG. 7A.

In operation 1121, the intent handler module 550 may verify that a precondition according to an order of an execution path described in the voice metadata is to “turn on the TV power,” and obtain a power state (e.g., OFF or false) of the target device 502. In operation 1123, the intent handler module 550 may determine that the power state (e.g., OFF or false) of the target device 502 does not satisfy the precondition for turning on the TV power (e.g., ON or true), and generate reverse voice metadata on the power state (e.g., OFF or false) of the target device 502 and then output the reverse voice metadata and the power state (e.g., OFF or false) of the target device 502 to the device state snapshot module 570. The power state (e.g., OFF or false) of the target device 502 may be stored in the second storage 573 of the device state snapshot module 570, and the reverse voice metadata on the power state (e.g., OFF or false) of the target device 502 may be stored in the third storage 575 as the reverse voice metadata of the target device 502. In operation 1125, the intent handler module 550 may transmit, to the target device 502, a command allowing the target device 502 to perform an operation of turning on the power.

In operation 1131, the intent handler module 550 may verify that a subsequent precondition according to the order of the execution path described in the voice metadata is to “set the TV volume to a specified volume (e.g., volume 100), and obtain a volume state (e.g., volume 30) of the target device 502. In operation 1133, the intent handler module 550 may determine that the volume state (e.g., volume 30) of the target device 502 does not satisfy the precondition for setting the TV volume to a specified volume (e.g., volume 100), and generate reverse voice metadata on the volume state (e.g., volume 30) of the target device 502 and then output the reverse voice metadata and the volume state (e.g., volume 30) of the target device 502 to the device state snapshot module 570. The volume state (e.g., volume 30) of the target device 502 may be stored in the second storage 573 of the device state snapshot module 570, and the reverse voice metadata on the volume state (e.g., volume 30) of the target device 502 may be overwritten in the reverse voice metadata of the target device 502 in the third storage 575. In operation 1135, the intent handler module 550 may transmit, to the target device 502, a command allowing the target device 502 to perform an operation of setting (e.g., adjusting) the volume to 100.

In operation 1141, the intent handler module 550 may verify that a subsequent precondition according to the order of the execution path described in the voice metadata is to “change a sound mode to a specified mode (e.g., a movie mode),” and obtain a sound mode state (e.g., a standard mode) of the device 502. In operation 1143, the intent handler module 550 may determine that the sound mode state (e.g., the standard mode) of the target device 502 does not satisfy the precondition for changing the sound mode to a specified mode (e.g., the movie mode), and generate reverse voice metadata on the sound mode state (e.g., the standard mode) of the target device 502 and then output the reverse voice metadata and the sound mode state (e.g., the standard mode) of the target device 502 to the device state snapshot module 570. The sound mode state (e.g., the standard mode) of the target device 502 may be stored in the second storage 573 of the device state snapshot module 570, and the reverse voice metadata on the sound mode state (e.g., the standard mode) of the target device 502 may be overwritten in the reverse voice metadata of the target device 502 in the third storage 575. In operation 1145, the intent handler module 550 may transmit, to the target device 502, a command allowing the target device 502 to perform an operation of setting (e.g., adjusting) the sound mode to the movie mode.

In operation 1151, the intent handler module 550 may transmit, to the target device 502, a command allowing the target device 502 to perform an action of running the Netflix app.

In response to the user’s utterance “Run Netflix (or Netflix mode),” the target device 502 may change from a original state in which the power is OFF, the volume is 30, and the sound mode is the standard mode, to a post-utterance state in which the power is ON, the volume is 100, and the sound mode is the movie mode.

FIG. 11B is a diagram illustrating a flow of operations of restoring a device state of the target device 502 that is changed by a user’s utterance (e.g., “Change the mode of the TV in the living room to Netflix mode”) to a previous state, in response to a user’s utterance (e.g., “Cancel the Netflix mode of the TV in the living room”). Operations 1161 through 1175 to be described hereinafter may be performed in sequential order, but not be necessarily performed in sequential order. For example, operations 1161 through 1175 may be performed in different orders, and at least two of operations 1161 through 1175 may be performed in parallel.

In operation 1161, the external electronic device 610 may receive a user’s utterance (e.g., “Cancel the Netflix mode of the TV in the living room”) through a microphone. In operation 1163, the external electronic device 610 may convert the user’s utterance into a voice signal and transmit the voice signal to the electronic device 501. In operation 1165, the voice recognition module 540 may analyze the user’s utterance and output, to the intent handler module 550, a user intent including information of the target device 502 and a voice intent.

In operation 1167, the intent handler module 550 may obtain reverse voice metadata of the target device 502 from the device state snapshot module 570 (e.g., the third storage 575 of the device state snapshot module 570) based on the user intent. An example of the reverse voice metadata of the target device 502 related to the user’s utterance “Cancel the Netflix mode of the TV in the living room” may be substantially the same as shown in FIG. 7B.

In operations 1171 through 1175, the intent handler module 550 may transmit rollback commands in sequential order according to an order of an execution path described in the reverse voice metadata such that the target device 502 rolls back from a post-utterance state to a first state. In detail, in operation 1171, the intent handler module 550 may transmit, to the target device 502, a rollback command allowing the target device 502 to perform an operation of reverting a sound mode to a standard mode. In operation 1173, the intent handler module 550 may transmit, to the target device 502, a rollback command allowing the target device 502 to perform an operation of reverting a volume to 30. In operation 1175, the intent handler module 550 may transmit, to the target device 502, a rollback command allowing the target device 502 to perform an operation of reverting a power state to OFF.

The target device 502 may change from a post-utterance state in which the power is ON, the volume is 100, and the sound mode is a movie mode, which is changed in response to a user’s utterance “Run Netflix (or Netflix mode), to a original state in which the power is OFF, the volume is 30, and the sound mode is a standard mode, which is before the change.

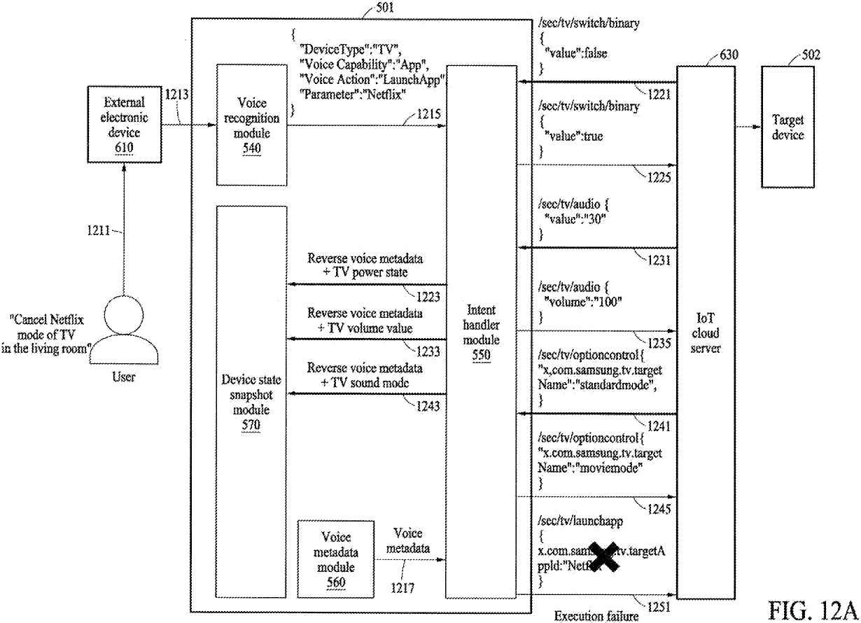

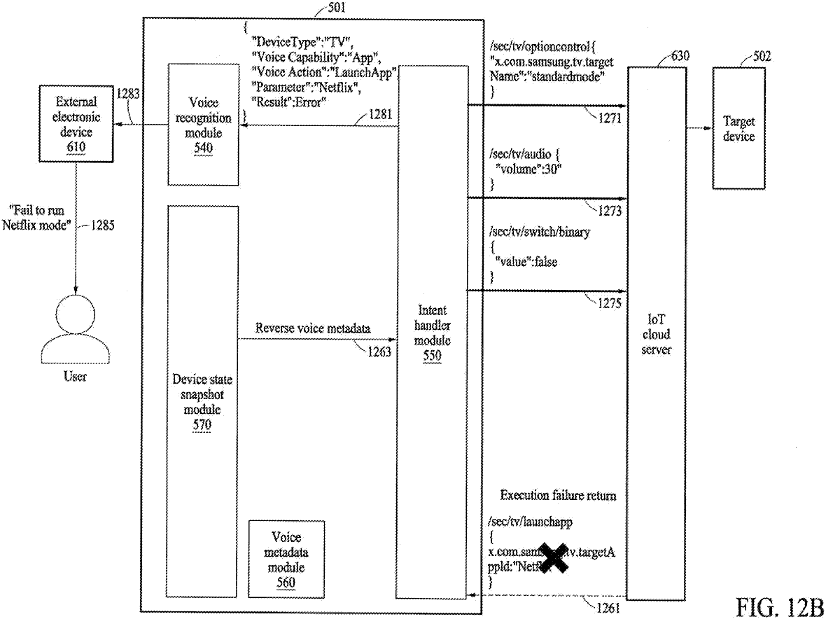

FIGS. 12A and 12B are diagrams illustrating another example operation of controlling a target device according to a user’s utterance according to an embodiment.

FIG. 12A is a diagram illustrating a flow of operations of controlling the target device 502 (e.g., a TV) using voice metadata according to a user’s utterance (e.g., “Change the mode of the TV in the living room to Netflix mode”), and generating reverse voice metadata of the target device 502. Operations 1211 through 1251 to be described hereinafter with reference to FIG. 12A may be substantially the same as operations 1111 through 1151 described above with reference to FIG. 11A. Unlike the example of FIG. 11A, it is assumed in the example of FIG. 12A that the execution of an action corresponding to the user’s utterance (e.g., “Change the mode of the TV in the living room to Netflix mode”) fails and the Netflix app does not run. Although the Netflix app is not executed in the target device 502, the target device 502 may be changed from a original state in which the power is OFF, a volume is 30, and a sound mode is a standard mode, to a post-utterance state in which the power is ON, the volume is 100, and the sound mode is a movie mode. Referring to FIG. 12B, in response to a failure in sequential execution of commands according to the user’s utterance (e.g., “Change the mode of the TV in the living room to Netflix mode”), the following operations may be performed to restore, to a previous state, a device state of the target device 502 changed before the failure in the execution. Operations 1261 through 1285 may be performed in sequential order, but not be necessarily performed in sequential order. For example, operations 1261 through 1285 may be performed in different orders, and at least two of operations 1261 through 1285 may be performed in parallel.

In operation 1261, the intent handler module 550 may receive a returned execution failure. In operation 1263, in response to the execution failure, the intent handler module 550 may obtain reverse voice metadata of the target device 502 from the device state snapshot module 570 (e.g., the third storage 575 of the device state snapshot module 570). An example of the reverse voice metadata of the target device 502 may be as shown in FIG. 7B.

In operations 1271 through 1275, the intent handler module 550 may sequentially transmit rollback commands in an order of an execution path described in the reverse voice metadata such that the target device 502 rolls back from the post-utterance state to the first state. In operation 1271, the intent handler module 550 may transmit, to the target device 502, a rollback command allowing the target device 502 to perform an operation of reverting the sound mode to a standard mode. In operation 1273, the intent handler module 550 may transmit, to the target device 502, a rollback command allowing the target device 502 to perform an operation of reverting the volume to 30. In operation 1275, the intent handler module 550 may transmit, to the target device 502, a rollback command allowing the target device 502 to perform an operation of reverting the power state to OFF.

In operation 1281, the intent handler module 550 may output, to the voice recognition module 540, an execution result (e.g., Error) from a user’s utterance (e.g., “Run Netflix mode of the TV in the living room”) after the rollback of the target device 502 is completed. In operation 1283, the voice recognition module 540 may output a response to the user’s utterance (e.g., “Run Netflix mode of the TV in the living room”) based on the execution result. In operation 1285, the external electronic device 610 may provide the response (e.g., “Fail to execute Netflix mode”) to the user.

The target device 502 may restore a post-utterance state in which the power is ON, the volume is 100, and the sound mode is a movie mode, which is changed by a user’s utterance “Run Netflix (or Netflix mode),” to a original state in which the power is OFF, the volume is 30, and the sound mode is a standard mode.

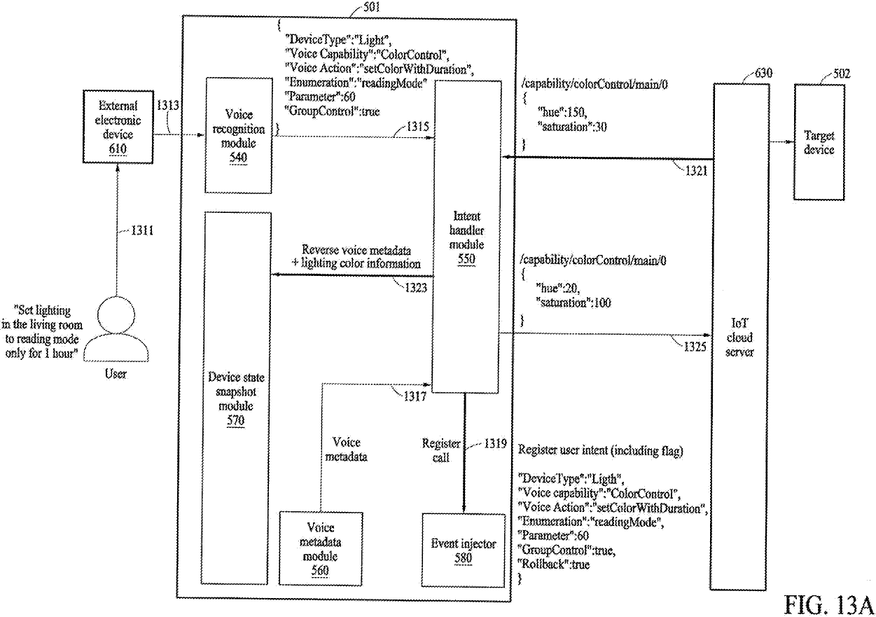

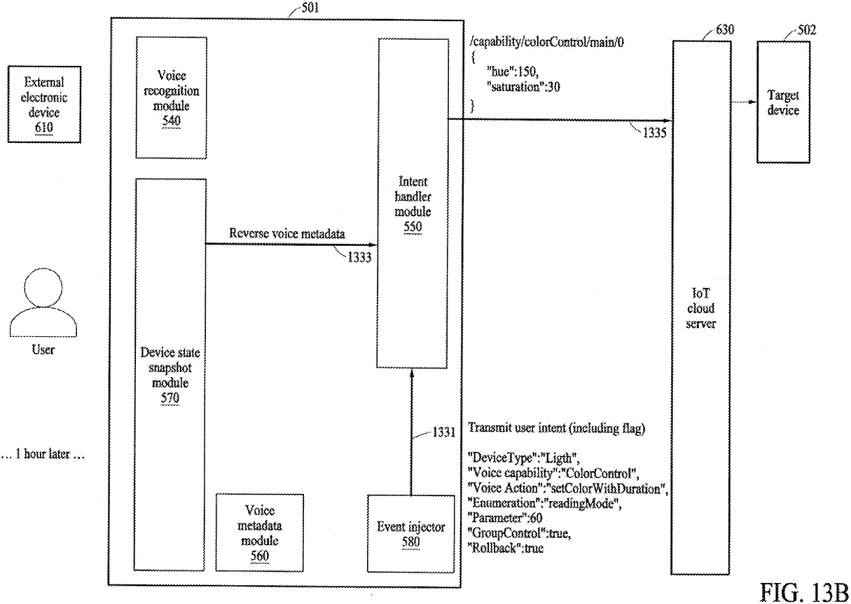

FIGS. 13A and 13B are diagrams illustrating still another example operation of controlling a target device according to a user’s utterance according to an embodiment.

FIG. 13A is a diagram illustrating a flow of operations of controlling the target device 502 (e.g., lighting) using voice metadata according to a user’s utterance (e.g., “Set the lighting in the living room to reading mode only for 1 hour”), and generating reverse voice metadata of the target device 502. Operations 1311 through 1325 to be described hereinafter may be performed in sequential order, but not be necessarily performed in sequential order. For example, operations 1311 through 1325 may be performed in different orders, and at least two of operations 1311 through 1325 may be performed in parallel. For the convenience of description, a current state of the target device 502 is assumed that the power is turned on and color information indicates ‘hue 150’ and ‘saturation 30.’

In operation 1311, the external electronic device 610 may receive a user’s utterance (e.g., “Set the lighting in the living room to reading mode only for 1 hour”) through a microphone. The external electronic device 610 may obtain a voice signal from the user’s utterance. In operation 1313, the external electronic device 610 may transmit the voice signal to the electronic device 501.

In operation 1315, the voice recognition module 540 may analyze the user’s utterance, and recognize information of the target device 502 and a voice intent and output, to the intent handler module 550, a user intent including the information of the target device 502 and the voice intent.

In operation 1317, the intent handler module 550 may obtain voice metadata related to the user’s utterance from the voice metadata module 560 based on the user intent. In operation 1319, the intent handler module 550 may request the event injector 580 to call (or invoke) the user intent as data after a predetermined period of time elapses based on the user intent (e.g., to keep the target device 502 in the reading mode for only 1 hour). In this case, a flag “Rollback: true” may be included in the user intent and registered in the event injector 580.

In operation 1321, the intent handler module 550 may verify “setting color information in the reading mode to specified color information” (e.g., hue 20 and saturation 100) based on the voice metadata, and obtain a color information state (e.g., hue 150 and saturation 30) of the target device 502. In operation 1323, the intent handler module 550 may determine that the color information state (e.g., hue 150 and saturation 30) of the target device 502 does not satisfy a precondition for “setting the color information in the reading mode to specified color information (e.g., hue 20 and saturation 100), and generate reverse voice metadata on the color information state (e.g., hue 150 and saturation 30) of the target device 502 and then output the generated reverse voice metadata and the color information state (e.g., hue 150 and saturation 30) of the target device 502 to the device state snapshot module 570. The color information state (e.g., hue 150 and saturation 30) of the target device 502 may be stored in the second storage 573 of the device state snapshot module 570, and the reverse voice metadata on the color information state (e.g., hue 150 and saturation 30) of the target device 502 may be stored in the reverse voice metadata of the target device 502 in the third storage 575. In operation 1325, the intent handler module 550 may transmit, to the target device 502, a command allowing the target device 502 to perform an operation of setting (e.g., adjusting) the color information to hue 20 and saturation 100.

The target device 502 may change from a original state in which the color information indicates hue 150 and saturation 30 to a post-utterance state in which the color information indicates hue 20 and saturation 100, in response to the user’s utterance “Set the lighting in the living room to reading mode for only 1 hour.”

Referring to FIG. 13B, after a device state of the target device 502 is changed by a user’s utterance (e.g., “Set the lighting in the living room to reading mode only for 1 hour”), the following operations may be performed to restore the changed device state to a previous state after a predetermined period of time (e.g., 1 hour) based on a user’s intent elapses. Operations 1331 through 1335 may be performed in sequential order, but not be necessarily performed in sequential order. For example, operations 1331 through 1335 may be performed in different orders, and at least two of operations 1331 through 1335 may be performed in parallel.

In operation 1331, the event injector 580 may output, to the intent handler module 550, a user intent including a flag of “Rollback: true” after a predetermined time has elapsed, and call (or invoke) the intent handler module 550. In operation 1333, the intent handler module 550 may obtain reverse voice metadata of the target device 502 from the device state snapshot module 570 (e.g., the third storage 575 of the device state snapshot module 570). In operation 1335, the intent handler module 550 may transmit, to the target device 502, a rollback command allowing the target device 502 to perform an operation of reverting the color information to hue 150 and saturation 30 based on the reverse voice metadata.

The target device 502 may restore a post-utterance state in which the color information indicates hue 20 and saturation 100, which is changed by the user’s utterance “Set the lighting in the living room to reading mode only for 1 hour,” to a original state in which the color information indicates hue 150 and saturation 30.

According to an embodiment, an electronic device (e.g., the electronic device 101 of FIG. 1, the electronic device 201 of FIG. 2, the intelligent server 290 of FIG. 2, or the electronic device 501 of FIG. 5) may include a memory (e.g., the memory 130 of FIG. 1, the memory 207 of FIG. 2, or the memory 530 of FIG. 6) storing therein instructions, and a processor (e.g., the processor 120 of FIG. 1, the processor 203 of FIG. 2, or the processor 520 of FIG. 6) electrically connected to the memory and configured to execute the instructions. When the instructions are executed by the processor, the processor perform a plurality of operations comprising: when a first utterance from a user is a command for a target device, obtaining state information on for an original state of the target device (e.g., operation 1010 of FIG. 10); and generating reverse voice metadata of the target device for reverting to the original state from a post-utterance state of the target device based on the state information on the original state (e.g., operation 1020 of FIG. 10). The original state may be a state of the target device before being changed by the first utterance, and the post-utterance state may be a state of the target device after being changed by the first utterance.

The processor may generate the reverse voice metadata (or rollback voice metadata) of the target device based on voice metadata related to the first utterance and the state information on the original state. The voice metadata may indicate an order of executing a plurality of commands, wherein the plurality of commands sequentially satisfy preconditions required to perform an action corresponding to the first utterance.

The processor may determine whether there is a precondition for the target device to perform the action corresponding to the first utterance based on voice metadata related to the first utterance; obtain, as the state information for the original state, state information of the target device related to one or more conditions that are not satisfied by the target device among the preconditions; and generate the reverse voice metadata based on the state information for the original state.

The processor may control the target device to revert from the post-utterance state to the original state based on the reverse voice metadata.

In response to a reversion event for the target device, the processor may reverting the state of the target device to the original state using the reverse voice metadata.

The reversion event may include at least one of an intent of the first utterance, an execution state of the target device according to the first utterance, or a second utterance from the user.

The intent of the first utterance may be to maintain the post-utterance state of the target device only for a predetermined period of time according to the first utterance.

The execution state of the target device may indicate a failure in the execution of the control command received according to the first utterance.

The second utterance may be to cancel the execution according to the first utterance.

Each time obtaining the state information for the original state, the processor may overwrite, in the reverse voice metadata, a command for reverting to the obtained state information.

According to an embodiment, an operation method of an electronic device (e.g., the electronic device 101 of FIG. 1, the electronic device 201 of FIG. 2, the intelligent server 290 of FIG. 2, or the electronic device 501 of FIG. 5) may include: in response to a first utterance from a user being a device control command for a target device to be controlled, obtaining state information on a original state of the target device (e.g., operation 1010 of FIG. 10); and generating reverse voice metadata for reverting to the original state from a post-utterance state of the target device based on the state information on the original state (e.g., operation 1020 of FIG. 10). The original state may be a state of the target device before being changed by the first utterance, and the post-utterance state may be a state of the target device after being changed by the first utterance.

The generating may include generating the reverse voice metadata based on voice metadata related to the first utterance and the state information on the original state. The voice metadata is an indicator of an order of executing a plurality of commands, wherein the plurality of commands sequentially satisfy preconditions for the target device to perform an action corresponding to the first utterance.

The generating of the reverse voice metadata may include: determining whether there is a precondition for the target device to perform the action corresponding to the first utterance, based on voice metadata related to the first utterance; obtaining, as the state information on the original state, state information of the target device related to one or more conditions that are not satisfied by the target device among the preconditions; and generating the reverse voice metadata based on the state information on the original state.

The operation method may further include controlling the target device to revert from the post-utterance state to the original state based on the reverse voice metadata.

In response to a reversion event for the target device, the controlling may include executing a rollback on the target device using the reverse voice metadata.

The reversion event may include at least one of an intent of the first utterance, an execution state of the target device according to the first utterance, or a second utterance from the user.

The intent of the first utterance may be to maintain the post-utterance state of the target device only for a predetermined period of time according to the first utterance.

The execution state of the target device may indicate a failure in the execution of the device control command received according to the first utterance.

The second utterance may be to cancel the execution according to the first utterance.

Each time obtaining the state information on the first state, the generating may include overwriting, in the reverse voice metadata, a command for reverting to the obtained state information.

While the present disclosure has been shown and described with reference to certain embodiments thereof, it will be understood by those skilled in the art that various changes in form and details may be made therein without departing from the present disclosure as defined by the appended claims and their equivalents.

What is claimed is:

1. An electronic device, comprising:
a memory configured to store instructions; and
a processor electrically connected to the memory and configured to execute the instructions,
wherein, when the instructions are executed by the processor, the processor performs a plurality of operations, the plurality of operations comprising:
when a first utterance from a user is a command for a target device, obtaining state information for an original state of the target device; and
generating reverse voice metadata for the target device to revert to the original state from a post-utterance state of the target device based on the state information on the original state,
wherein the original state is a state of the target device before being changed by the first utterance, and the post-utterance state is a state of the target device changed by the first utterance.

2. The electronic device of claim 1, wherein
generating the reverse voice metadata comprises generating the reverse voice metadata based on voice metadata related to the first utterance and the state information for the original state,
wherein the voice metadata is an indicator of an order of executing a plurality of commands, wherein the plurality of commands sequentially satisfy preconditions required to perform an action corresponding to the first utterance.

3. The electronic device of claim 2, wherein to the plurality of operations further comprises:
determining whether there is a precondition for the target device to perform the action corresponding to the first utterance, based on voice metadata related to the first utterance; and
obtaining, as the state information for the original state, state information of the target device related to one or more conditions that are not satisfied by the target device among the preconditions; and
generating the reverse voice metadata based on the state information on for the original state.

4. The electronic device of claim 1, wherein the plurality of operations further comprises:
controlling the target device to revert to the original state from the post-utterance state based on the reverse voice metadata.

5. The electronic device of claim 4, wherein the plurality of operations further comprises:
in response to a reversion event for the target device, reverting the state of the target device to the original state using the reverse voice metadata.

6. The electronic device of claim 5, wherein the reversion event comprises at least one of an intent of the first utterance, an execution state of the target device according to the first utterance, or a second utterance from the user.

7. The electronic device of claim 6, wherein the intent of the first utterance is to maintain the post-utterance state of the target device only for a predetermined period of time according to the first utterance.

8. The electronic device of claim 6, wherein the execution state of the target device indicates a failure in executing the control command received according to the first utterance.

9. The electronic device of claim 6, wherein the second utterance is to cancel the execution according to the first utterance.

10. The electronic device of claim 1, wherein the plurality of operations further comprises:
obtaining the state information for the original state each time, overwriting, in the reverse voice metadata, a command for reverting to the obtained state information.

11. An operation method of an electronic device, comprising:
when a first utterance from a user is a command for a target device, obtaining state information for an original state of the target device; and
generating reverse voice metadata for the target device to revert to the original state from a post-utterance state of the target device based on the state information on the original state,
wherein the original state is a state of the target device before being changed by the first utterance, and the post-utterance state is a state of the target device changed by the first utterance.

12. The operation method of claim 11, wherein generating the reverse voice metadata comprises:
generating the reverse voice metadata based on voice metadata related to the first utterance and the state information on the original state,
wherein the voice metadata is an indicator of an order of executing a plurality of commands, wherein the plurality of commends sequentially satisfying preconditions required to perform an action corresponding to the first utterance.

13. The operation method of claim 12, wherein generating of the reverse voice metadata comprises:
determining whether there is a precondition for the target device to perform the action corresponding to the first utterance based on voice metadata related to the first utterance; and
obtaining, as the state information for the original state, state information of the target device related to one or more conditions that are not satisfied by the target device among the preconditions; and
generating the reverse voice metadata based on the state information on for the original state.

14. The operation method of claim 11, further comprising:
controlling the target device to revert to the original state from the post-utterance state based on the reverse voice metadata.

15. The operation method of claim 14, wherein the controlling comprises:
in response to a reversion event for the target device, reverting the state of the target device to the original state using the reverse voice metadata.

16. The operation method of claim 15, wherein the reversion event comprises at least one of an intent of the first utterance, an execution state of the target device according to the first utterance, or a second utterance from the user.

17. The operation method of claim 16, wherein the intent of the first utterance is to maintain the post-utterance state of the target device only for a predetermined period of time according to the first utterance.

18. The operation method of claim 16, wherein the execution state of the target device indicates a failure in executing the device control command received according to the first utterance.

19. The operation method of claim 16, wherein the second utterance is to cancel the execution according to the first utterance.

20. The operation method of claim 11, wherein the generating comprises:
each time obtaining the state information on the first state, overwriting, in the reverse voice metadata, a command for reverting to the obtained state information.
